(19) United States
(12) Patent Application Publication
(10) Pub. No.: US 2017/0140473 A1
(43) Pub. Date: May 18, 2017

(54) METHOD AND A SYSTEM FOR PUBLISHING FINANCIAL ACCOUNT DATA

(71) Applicant: Frank Money, Inc., Emerald Hills, CA (US)

(72) Inventors: David Liberman, Menlo Park, CA (US); Daniil Liberman, Menlo Park, CA (US)

(21) Appl. No.: 15/355,020

(22) Filed: Nov. 17, 2016

Related U.S. Application Data
(60) Provisional application No. 62/256,278, filed on Nov. 17, 2015.

(51) Int. Cl. G06Q 40/00; G06Q 40/02

(52) U.S. Cl. CPC G06Q 40/128; G06Q 40/02

(57) ABSTRACT

The current invention is directed to an electronic system and a method for open transparency and publishing of financial account transaction data, such as transactions by a charity or other entity, where transparency is encouraged. The system is comprised of a platform having a data repository for assembling and storing the account data such that it is freely accessible by users who desire to review, analyze, comment on, or otherwise inspect the substance of the transaction. In a method of the invention, the users access the financial account transaction data and interact the platform by means of user devices to perform a variety of activities including commenting on the data, reading the data, sharing the data, and other functions consistent with transparency of the financial account transaction data.

### CROSS-REFERENCE TO RELATED APPLICATIONS

The present application claims priority to U.S. Provisional Patent Application Ser. No. 62/256,278, filed Nov. 17, 2015. The above-referenced application is incorporated herein by reference as if restated in full.

### TECHNICAL FIELD

The present invention relates generally to the field of electronic systems designed for collection, storage, analysis or publication of financial account data. More particularly the present invention relates to special modifications to a computer-based system for publishing financial data, and altering the data flow within customized computer systems to create new hierarchies of financial data and data exchange

### BACKGROUND

Electronic communications and computer-based technologies in the field of finance have rapidly developed in recent years, and a huge variety of Internet-based systems providing financial facilities communication services and distribution services of financial information data, have become more popular and enable the exchange of information among a large number of people.

For example, classic financial institutions such as banks, building societies, credit unions, trust companies, mortgage loan companies, insurance companies as well as pension funds, use services such as electronic payment systems, payment institutions, online accountancy services, digital wallets, etc. for providing financial facilities. Virtually all financial institutions have a website featuring online banking, to provide customers of the institution with the ability to conduct financial transactions within a personal bank account. These facilities go to great lengths to insure that account and transaction information remain confidential and secure, that other individuals have no access to the detailed personal account information of a customer

Nevertheless, in the modern world, openness and transparency are key factors for reliability and trust between people and organizations. In this environment, a critical need exists for new technology and solutions to allow customers to publish personal and account information when desired, so that other people or organizations can enjoy absolute transparency and access publicly available information regarding bank account, financial transactions and other related information. For example, there is a need to open a transparent and trustworthy checking account, that may help for-profit and non-profit organizations provide transparency regarding acceptance of donations from persons or organizations with the ability to provide the public access to the details of these transactions, related financial activity, and the goals stated or adopted by organizations, together with, integrated reports relating to donations, financial goals, and all other parameters of charitable giving.

Although organizations (for-profit or non-profit) periodically publish their financial reports, these reports are typically prepared by accountants in accord with accounting standards that deal with accuracy and completeness and may not contain full information about financial activity of a particular organization where the organization desires maximum transparency for donors and the public. Moreover, there are some standards of the financial reports, wherein the published information may be processed and represented only in a limited fashion, or according to existing financial or accounting standards that do comply with financial or accounting standards, but do not provide significant transparency. Nevertheless, above and beyond complying with accounting standards, people or companies who invest money in these organizations are interested in the tools of tracking, analyzing, auditing or even partly participating in financial activity within the bank account of the organization (or recipient). Under such circumstances, a need arises to have full access to personal or bank account information of the project or organization allowing interested parties to track and evaluate the impact of the investing, and the efficiency and activity of the organization as well as other information. To achieve these goals, existing computer systems and data processing techniques and hierarchies may need to be modified in order to alter the operation of a computer system that processes these transactions.

Moreover charitable, political or social campaigns are interested in a tool for providing transparency of financial transactions, in a comfortable technological environment that provides financial reports, information, involvement and new donations and other financial information.

### SUMMARY

The present invention is related to a system and a method for publishing bank account data, by altering a computer-based environment and data processing system that opens transparent accounts that provide for-profit and non-profit organizations, government structures and individuals, the opportunity to publish the reliable information about their account transactions, tools for allowing access to donations and other financial transactions, facilitate informal and formal audit and analysis of published financial data, and provide transparency such that interested parties have an opportunity to evaluate transactions, to make and review transactions, enter comments, review the comments of others, and share comments and transactions with other users who desire the same level of transparency.

Disclosed are systems, methods, and computer programs for processing financial account data, including a method and a system for publishing a financial account data comprising permitting access to the financial account data; transmitting the financial account data to the platform to publish the financial account data, wherein the platform comprises a data repository for assembling and storage said financial account data, wherein data repository is located within at least one computer-based system or server, wherein the computer-based system or server as at least one processor unit, memory unit, and data-storage unit, wherein at least one computer-based system or server electronically communicates with remote one or more processor-controlled user device(s) and other computer-based systems or servers through a communications environment. The data processing system includes a hierarchy of rules involving commands within at least one computer-based systems or server to receive requests from the processor-controlled user devices and two transmit responses to the requests to the processor-controlled user devices, wherein the processor-controlled user devices comprise one or more interactive user graphical interface(s) for interaction of a user with the platform, wherein such requests comprise receiving information about financial account data by the processor-controlled user devices; displaying the information about financial account data on displays of the processor-controlled user devices; and distributing the information about financial account data to the processor-controlled user devices.

The above summary is not an extensive overview of all contemplated aspects, and is intended to neither identify key or critical elements of all aspects nor delineate the scope of any or all aspects of the present disclosure.

### BRIEF DESCRIPTION OF THE DRAWINGS

FIG. 1A is a general architectural diagram of an illustrative system of the invention.

FIG. 1AA is an example of the system of invention.

FIG. 1AAA is a cloud computing paradigm.

FIG. 1B is an example interacting with the system of invention in accordance with one example aspect.

FIG. 1C is an example of publishing selected transactions.

FIG. 2A is a method of registration of a user in the system of the present invention.

FIG. 2B is a method of opening an account for personal goals.

FIG. 2C is an example of registration of an account for an organization.

FIG. 3A is an example of a registration of an account through the site of a partner.

FIG. 4 is an example of a profile of a registered user.

FIG. 5 is an example of a dashboard, wherein the dashboard is a customizable screen, which compactly and visually displays vital information on different aspects of the system.

FIG. 6A is an example of a screen with account information that may be presented by an interface in web browser.

FIG. 6B is an example screen with account news.

FIG. 6C is an example page with analytic tools.

FIG. 6D is a representation to the user of information about transactions.

FIG. 6DD is an example of a screenshot with information about transactions.

FIG. 6DDD is an example of a screenshot with detailed information about a transaction.

FIG. 6DDD1 is an example screenshot with a display area having a discussion sign in.

FIG. 6DDD2 is an example of a screenshot with a thread of the discussion about the published transaction.

FIG. 6DDD3 is an example screenshot with six categories of comments.

FIG. 6DDD4 is an example of a screenshot with different categories of transactions.

FIG. 7 is an example browser page or page in the mobile application, which may be used for user interaction with the system for planning and completing payments.

FIG. 8 is an example of a distributed computer system that has a connection with the Internet.

FIG. 9 is an example of a peer-to peer network system

The following detailed specification makes references to the accompanying drawings. The same symbols in the drawings refer to the same components, unless otherwise indicated. The sample aspects presented in the detailed specification, the drawings and the patent claims are not the only ones possible. The example aspects can be used or modified by other methods not described below, without abridging their scope or their essence. The different variants presented in the specification of the example aspects and illustrated by the drawings can be arranged, replaced and grouped in a broad selection of different configurations, which are examined in detail in the present specification.

### DETAILED DESCRIPTION

The invention described herein in the context of a system and a method for providing a tool for publishing information of a bank account data, tool for performing access to information of financial transactions, analysis and auditing of published financial data and an opportunity for users to evaluate transactions, making and reviewing comments and share this information to other users

Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments. In the context of the present invention, the terms “a” and “an” mean “at least one”.

The present invention comprises a system and a method for publishing reliable financial account data (of the account in the financial institution or electronic payment services providing financial facilities, for example in the bank), for permitting access or performing an access step for information relating to financial transactions for the accounts analysis and auditing of published financial data. Moreover, the system of the invention may include a data repository for storage information about all transactions of the accounts.

The term “reliable data” means that all data in the data repository stores the information about the initial source of this data. As a consequence, operation of the system (represent, publish, transfer, etc.) may not occur with only part of the data and information may not be deliberately deleted in whole or part. When the data about a transaction is transmitted from the source financial institution, for example a bank, to the platform and stored in the data repository of the platform, the data may not be changed in any way. In one embodiment cryptographic methods are used for data authentication, for example a “proof of record” (authenticated transaction hash chain, ATHC). The authentication cannot be “rewound”, cannot be edited, and no transaction can be skipped or unpublished. When the data about the particular transaction is transmitted to the data repository of the platform, the transaction receives a hash that includes all information about the chain of previous transactions. With this implementation, verification of all the transaction data is enabled. Any method for data authentication may be used within the scope of the present invention as long as the integrity of transactional is maintained and may be verified.

The term “account” refers to any account in the financial institution or electronic service of the financial institution, such as bank, wherein account may mean a deposit or checking or transaction account held at a bank or other financial institution, which is available to the account owner “on demand” and is available for frequent and immediate access. An account allows an account holder to manage money on the balance of the account and may contain any type of information about the balance and transaction history.

The term “financial transaction” refers to any transaction with in an account, for example with a bank account or account in other financial institution or electronic financial services. Transactions may be incoming or outgoing.

An “open account” means that the information of account transactions that are performed within the account, wherein account may be in a bank or other financial institution, or with usage of the account are published (or shared) for all or some users of the system. The account data including all monetary transactions are publicly available, for example through possible modern devices and applications, such as web- and mobile applications and an API in real time.

In one embodiment hash chain provides the transparency of transaction data. Particularly, cryptographic methods are used for data authentication—a “proof of record” (authenticated transaction hash chain, ATHC). It cannot be “rewound”, it cannot be edited, and no transaction can be skipped or unpublished (although some details of the transaction can be hidden at client's discretion, e.g. donor's name). The hash is associated with the data that is transmitted from the financial institution to the data repository of the bank.

In comparison to other known systems that may provide the information about the transaction data, wherein data may be copied, printed, transferred, etc. without any request of validation of the trustworthiness, the present invention supplies the transaction data with the information about the source of this data. In one embodiment hash chain provides the transparency of the transaction data. When the data about the particular transaction is transmitted to the data repository of the platform, the transaction receives a hash. Every next transaction within the system also stores the history of the present transaction wherein it was involved, forming the hash chain. So the best chain consists of the longest series of transaction records. As a consequence every transaction data may be checked within the present system. All modifications in the transaction data may be easily found out.

By “user” we mean any person (or organization) who/which may interact with the system of invention. A user may be registered in the system and have his/her profile available for access and viewing. The description of a user profile may be represented with defined information or a pre-determined degree of transparency. Also users may be unregistered and access account information as a guest.

By “client” we mean a user registered in the system of the present invention, i.e. registered user, and who is recognized by the system as an account holder (account owner) of “open account”. The registered user is identified by the system as a “client” with regards to specific “open account”. Thus, the client of the system has a transparent bank account and may have certain “administrative rights” with regards such transparent account enabling “client” provide additional information to the transactions of such open account, identify other users as clients (administrators of open account), etc. The present invention is a computer-based system in the field of financial facilities that comprises a platform for collection, storage, analysis and auditing of data, publishing financial account data, providing access for, or publishing, information about financial account transactions, enabling “users” to comment on financial transactions and make said comments available to other “users”, wherein a “financial transaction” is an any transaction with a financial account, for example with a bank account or account in another financial institute or service. The platform may be an open platform. The term “an open platform” is referred to as a “software system, which is based on open standards, such as published and fully documented external applications using programming interfaces (or in other words, API) that allow using the software to function in other ways, without requiring modification of the source code. The open standard is a standard that is publicly available and has various rights to use associated with it, and may have various properties of how it was designed (e.g. open process). Using these interfaces, a third party could integrate with the platform to add functionality. Moreover, the platform of the present invention provides functions for social activity of registered users/clients such as evaluation, commenting, collaboration and sharing information from and to others, including “registered users”. The platform may have a Graphical User Interface (GUI) that provides for interaction of a “user” or a “client” with the platform. Interaction of a user with the platform may be performed for example through the mobile application or through the website.

The platform may be connected with at least one financial institution or payment service, for example with a bank. The financial institution may provide options for opening an account, providing classical bank transactions, performing a classical financial activity with a “transparent” account. Transparency of the account is provided by the platform. In other words, the system provides users with the opportunity to receive access to full information about account transactions. This access to information of financial transaction may be supported by agreement, for example by an agreement under which users of the system register for access or use of the system, or by agreements by which users of the system open an account and agree to grant rights to publish and give full or limited access to user transactional data and supportive information and comments for other users.

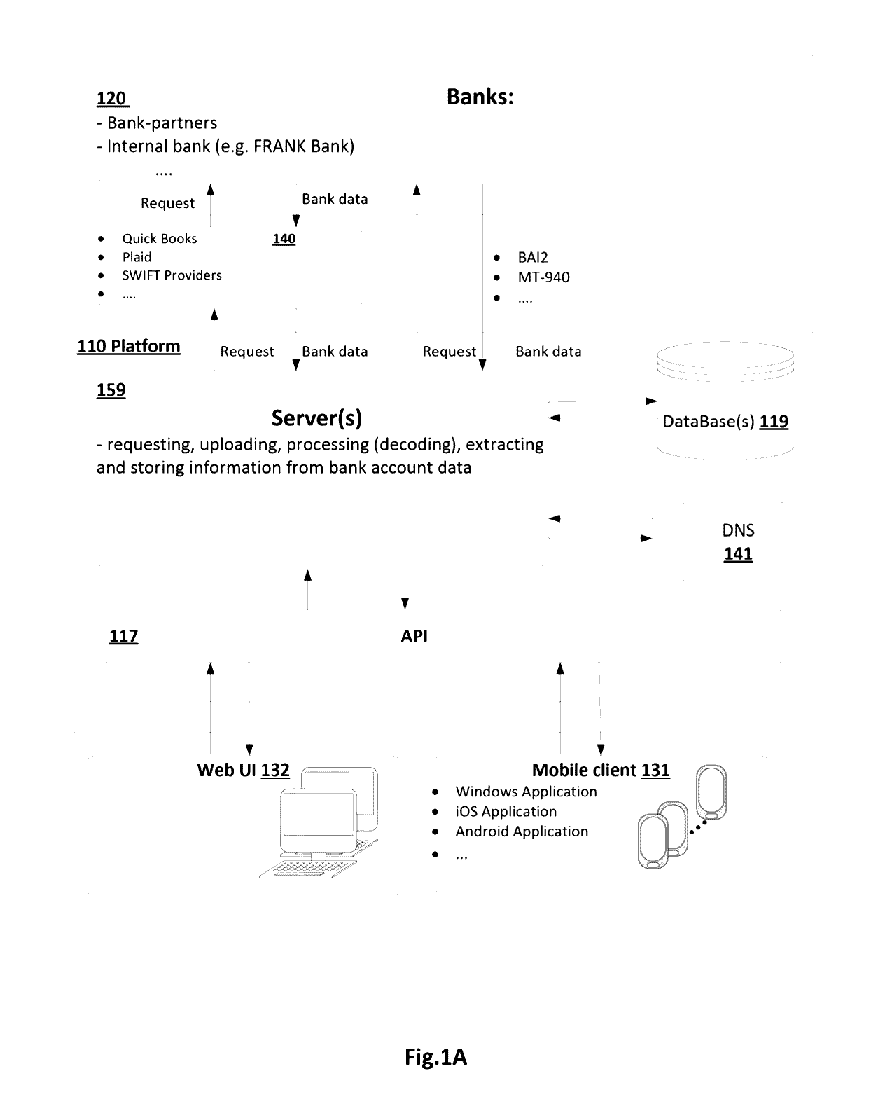

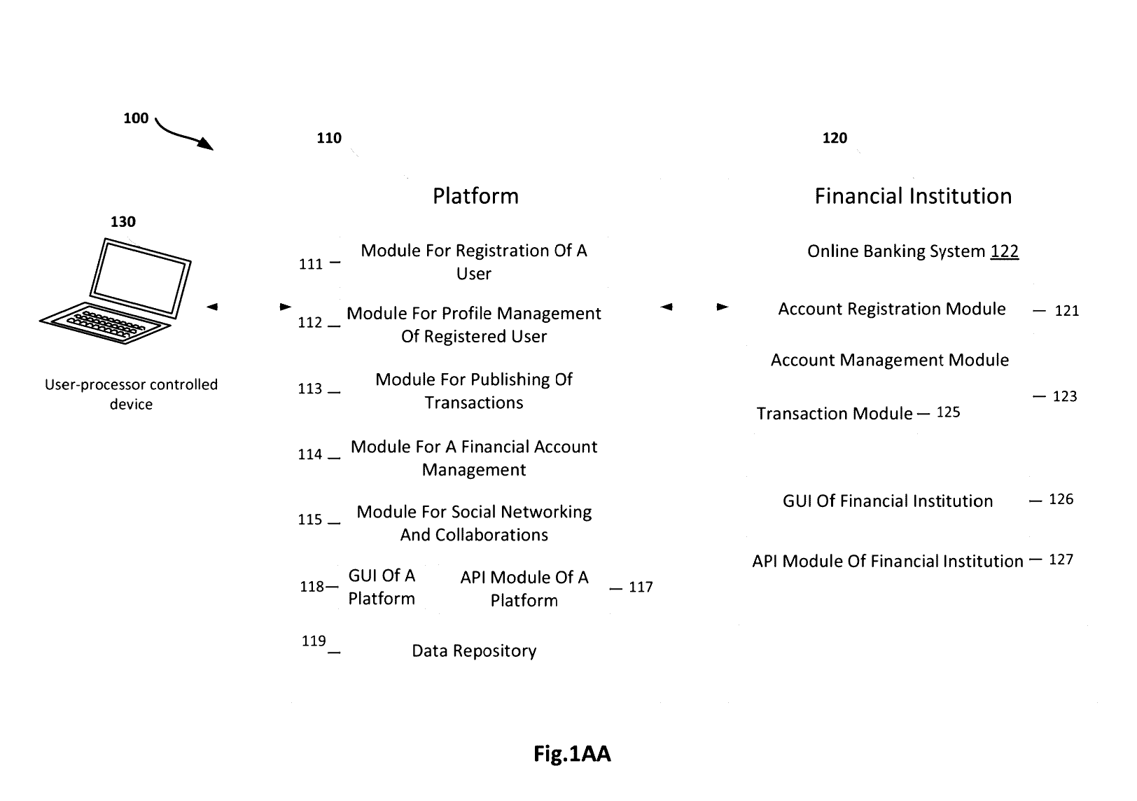

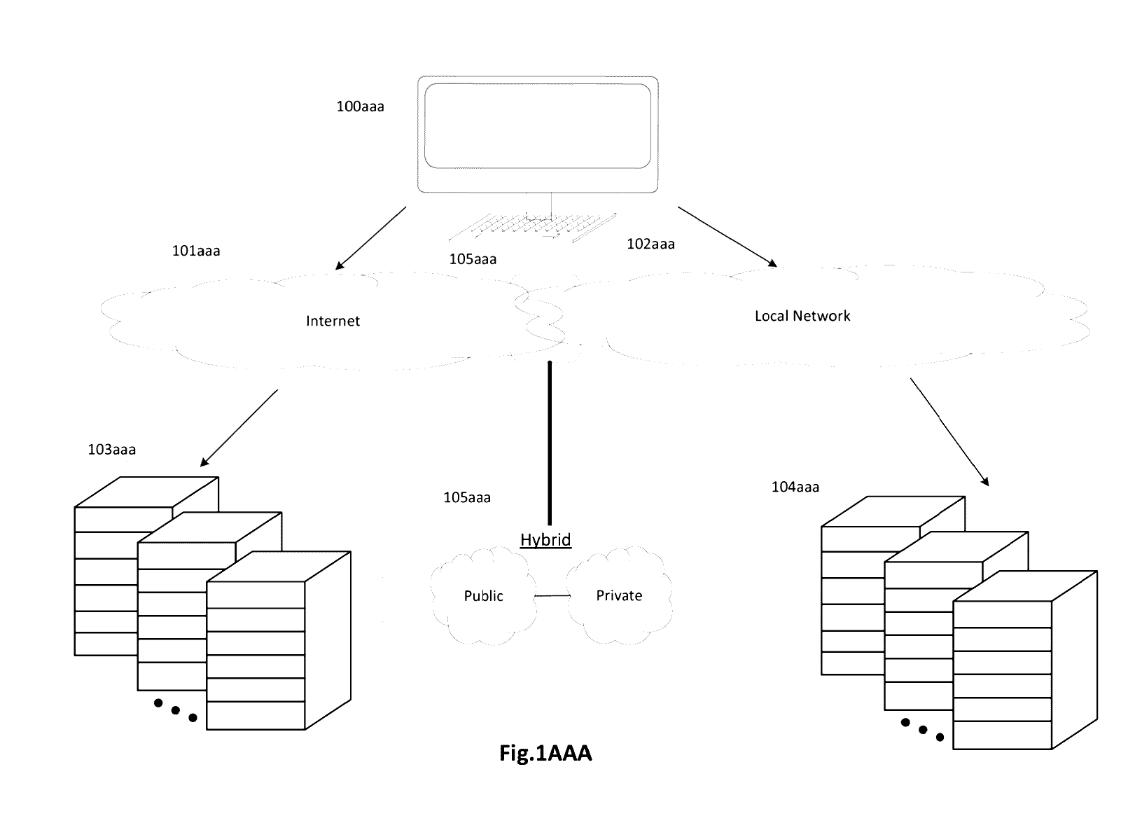

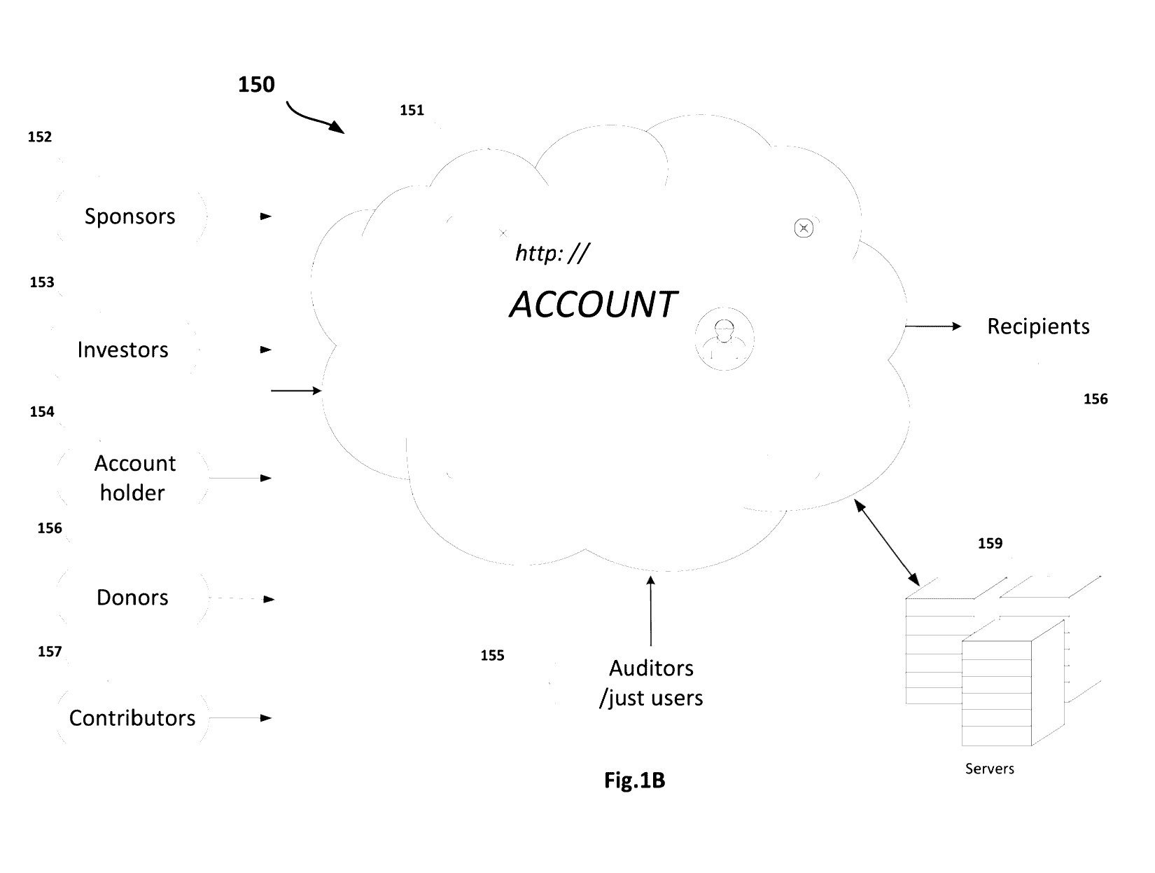

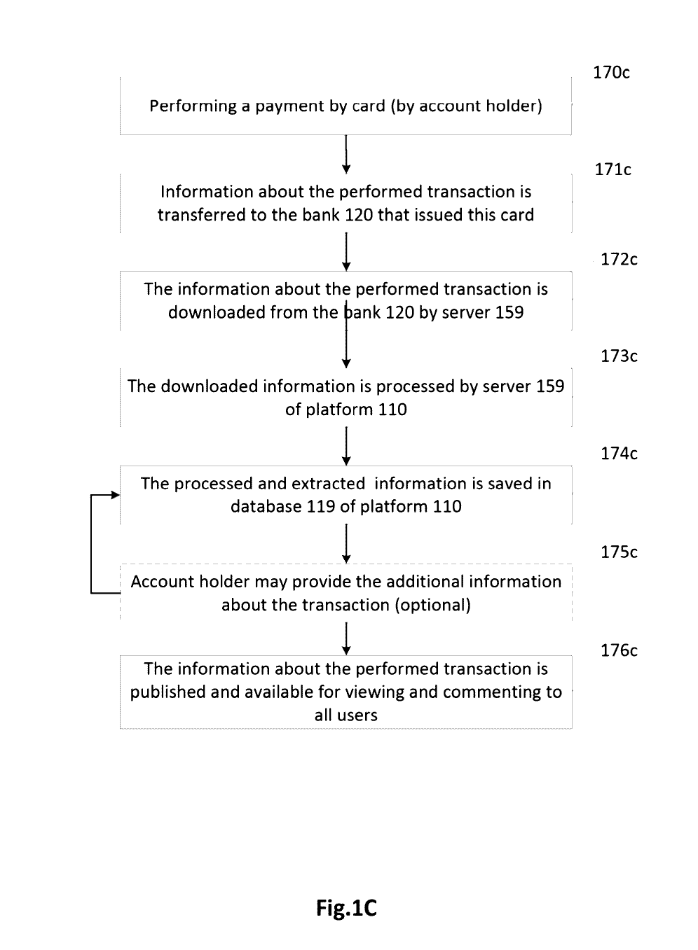

FIG. 1A is a general architectural diagram. Module 120 represents the financial institution, for example bank(s). The financial institution 120 may be represented by the bank-partner that allows direct and automatic (without user assistance) extraction of bank account data by the server 159 and downloading it to the Database 119. Also, module 120 may be represented by the internal bank that establishes the connection and interaction with the platform 110 for publishing data. The term “internal bank” may refer to the bank that was founded based on the platform and provides all possibilities as a partner bank.

The described architecture of the system of invention, namely the platform 110 includes the server (159). The server performs the following functions: requesting financial data from banks 120 and mobile clients 131 of user-controlled devices 130, receiving, processing, storing this data and preparing it for uploading by users. See FIG. 1AA. FIG. 1 AA describes five different modules as part of the platform 110. The modules of the platform are illustrative and do not limit the scope of the present invention.

The server(s) 159 store(s) received data in a database 119. The database 119 may be located on different servers in geographically remote places and may have a complicated system for information security, load distribution, or to execute specific functions. For example, cloud storage may be used, wherein cloud storage is one of the known models of data storage wherein the digital data is stored in logical pools, the physical storage spans multiple servers (and often locations), and the physical environment is typically owned and managed by a hosting company. These cloud storage providers are responsible for keeping the data accessible and available, and the physical environment protected and running.

The present invention may store transaction data linked to a previous transaction data by using of hash chain such that each transaction has information about the previous transaction(s). In particular, every unit of money is associated with the information in which the specific transaction for this unit of money was involved. Thus, the record(s) form a chain of records during the activity of the account holders (clients) within the system. Thus, the track for the path of the particular unit of money is authenticated and can be verified as a check on the history of the transaction and is protected by data encryption. FIG. 1AAA illustrates the cloud computing paradigm. According to current existing cloud-computing scheme, computing resources and storage facilities are provided to companies (legal entities) or individuals by cloud-computing hosting companies, or providers. Cloud computing and storage solutions provide users and enterprises with various capabilities to store and process their data in third-party data centers. Moreover, larger organizations may have private cloud-computing facilities in addition to, or instead of, subscribing to computing services provided by public cloud-computing service provider or have a hybrid cloud-computing facilities. Hybrid cloud service may be defined for example as a cloud computing service that is composed of some combination of private, public and community cloud services, from different service providers.

For example, in according to FIG. 1AAA, an administrator for any organization, using a personal computer (100aaa), can access the organization's private cloud (104aaa) through a local network (102aaa) and also accesses, through the Internet (101aaa), a public cloud (103aaa). Moreover the company may have hybrid cloud (105aaa). The administrator can, in either the case of the private cloud (104aaa) or public cloud (103aaa), establish virtual computer systems and even entire virtual data centers and launch execution of processing of data or running application programs on the virtual computer systems and virtual data centers in order to carry out any different type of computational task.

Referring again to FIG. 1A, the server 159 connects to the banks 120 via standard protocols, and receives bank account data, for example information about invoices and payments/transactions. In one embodiment the server (159) is connected to the financial institutes by standard protocol directly, for example by means of BAI, MT-940, MT-942 etc. or other known BAI file format for performing electronic cash management balance reporting. Conventional protocols allow access to transaction data from financial institutions.

The formats MT-940, MT-942 were developed to facilitate electronic data processing (payments or account statements). The SWIFT (Society for Worldwide Interbank Financial Telecommunication) formats MT940 and MT942 enables the export of account data. The structure of the information in MT940 files is based on the SWIFT format. SWIFT (Society for Worldwide lnterbank Financial Telecommunication) is an international, electronic communication network used by banks throughout the world for data exchange. The file consists of one or more messages. Each message consists of a Message Header, followed by a Customer Statement Message (MT940), which in turn is followed by a Message Trailer.

Periodically, for example daily, the server 159 requests the information from the financial institution 120 and uploads it. The information from the bank 120 is transmitted to the server 159 in the form of text files with coded information. Example of coded information is represented bellow:
{1:F01BPHKPLPKXXX0000000000}{2:1940BOFAUS6BXBAMN}{4:
:20:TELEWIZORY S.A.
:25:BPHKPLPK/320000546101
:28C:00084/001
:60F:C031002PLN40000,00
:61:0310201020C20000,00FMSCNONREF//8327000090031789
Card transaction
:86:020?00Wyplata-(dysp/przel)?2008106000760000777777777777?2115617?
22INFO INFO INFO INFO INFO INFO 1 END?23INFO INFO INFO INFO INFO
INFO 2 END?24ZAPLATA ZA FABRYKATY DO TUB?25-200 S ZTUK, TRANZY
STORY-?26300 SZT GR5441 OPORNIKI-5?2700 SZT GTX847 FAKTURA 333/
2?28003.?3010600076?310000777777777777?32HUTA SZKLA TOPIC UL
PRZEMY?33SLOWA 67 32-669 WROCLAW?38PL081060007600007777777
77777
:61:0310201020D10000,00FTRFREF 25611247//8327000090031790
Transfer
:86: 020?00Wyplata-(dysp/przel)?2008106000760000777777777777?2115617?
22INFO INFO INFO INFO INFO INFO 1 END?23INFO INFO INFO INFO INFO
INFO 2 END?24ZAPLATA ZA FABRYKATY DO TUB?25-200 S ZTUK, TRANZY
STORY-?26300 SZT GR544 I OPORNIKI-5?2700 SZT GTX847 FAKTURA 333/
2?28003.?3010600076?310000777777777777?38PL081060007600007777777
77777
:61:0310201020C40,00FTRFNONREF//8327000090031791
Interest credit
:86: 844?00Uznanie kwot odsetek?20Odsetki od lokaty nr 101000?21022086
:62F:C020325PLN50040,00}

The server 159 processes data directly (without the services of the third parties 140) received from financial institution 120, for example bank, text files to extract data and save it in the database 119. The processed and decoded information is saved in the database 119 and may be available for uploading by users. Data may be saved in the initial form, and may be converted to the internal storage format (for quick searching and linking with other data). The platform, namely the server 159 and user-controlled devices 130 that request the bank account information saved in the databases 119 may form the client-server model. In other embodiment the services of the third parties 140 may be used for uploading bank account data from financial institutions to the data repository 119 of the platform 110. For example, examples include the services of SWIFT Bureau (Axletree Solutions®), Plaid®, QuickBooks®, etc.

Applications, such as Windows Application, iOS Application, Android Application (on user-controlled devices 130) by means of mobile client 131 access the server 159 through the Application Programming Interface (API) 117—a software interface. Sites-partners by means of Web UI 132 obtain the information also through API

Applications 132, 131 provides a user (registered user, unregistered user, client) access to data in data repository 119 of the platform and allows to perform interaction with this data. For example, as it was already mentioned, the client may publish all data that are associated with his account (i.e. publication of transaction data via an application), manage his profile and account, perform social activity with other registered users or clients of the platform. Registered user may manage his profile, viewing the published transaction data of accounts, perform social activity with other users. Unregister user may have limited access to social activity and other functions of the system.

FIG. 1AA is a computer-based system comprises the platform 110 for publication of the bank account data, including a history of financial transactions. The platform may be an open platform. For example, in one implementation the platform may be represented as an online electronic financial service or payment service. But in the contrast to existing online financial service, the present one allows its users to publish the bank account data.

The platform for publication of financial transactions may be connected or integrated with any financial institution 120, wherein the financial institution allows a user of the system to open the classical transaction bank account and manage money in the balance of this account. A plurality of financial institutions or financial services companies may be connected to the platform 110 for publication of transactions.

A Financial institution 120 that is connected with the platform can integrate some of its own services, such as an internal service of that financial institution, for example of online banking system can connect to the platform and transfer information relating to transactions that are completed within the accounts to the platform 110. Detailed information about the accounts, including the history of transactions is stored in the module of data storage—databases 119. Transferring information about financial transactions or account from a bank to the platform may be performed automatically, for example by known technologies. The extracted data from the financial institutes are associated in the data repository 119 with information about the sources of this data in such way that this information cannot be deleted or modified.

In one embodiment of the present invention the financial institution 120 is connected with the platform 110 for example with usage of API modules, namely by a direct integration with the financial institution via the APIs. For example, the platform 110 may be connected to the financial institution 120 by API modules 117 of the platform 110 and API module 127 of the financial institution 120.

Moreover, exchanging data between the platform 110 and the financial institution (120) may be performed by usage third-party providers, such as PLAID®, Yoddle®, etc., which may receive information from the financial institution 120 and transmit this information to the platform, for example to the module of data storage 119 of the platform 110.

Files from financial institution 120 may be received by the platform 110 at the request of the client 130 or through the client 130, wherein the client 130 is a user who interacts with the platform and has at least one account in the financial institution 120. The Client may access the platform through the application 132 of processor-controlled devices 130, such as mobile phones, desktops, laptops and other electronic devices. For example, the financial institution 120 may send standard bank account statement to the client 130, and the client 130 may manually send this standard bank account statement to the platform 130. Alternatively, the financial institution 120 may provide the standard bank account statement in the client's personal cabinet in the online banking facility, and client 130 may give an access to the platform 110 to his personal cabinet in the online banking of financial institution 120.

Access to the account in the financial institution 120 and management of the balance of the account may be performed by client directly through the platform 110 by usage of a module of account management 114. For example the client 130 may initiate the transactions directly via the graphical user interface (GUI) of the platform 110. Information about the transactions initiated by the client 130 through the platform or other data about account management is transferred to the financial institution 120 by usage of any described above known technologies of exchange data. When the information about the initiated transaction is received, the financial institution 120 complete the transaction.

Module of account management (114) of the platform 110 is optional. The account management by an account holder, such as initiating transactions or changing personal information, may be performed on the side of financial institution 120, for example of the account management module 123 of the financial institution 120 by using the graphical user interface (GUI). In this case, information from financial institution 120 such as notifications, approval and information about incoming transactions, etc., may be transferred to the platform 110 by any known technology for data exchange

The present invention allows publication of bank account information even in the case when the bank account of the client is not connected to the platform 110 neither directly nor via third party providers 140. This case is possible when the customer of the bank desires to publish his/her financial data despite contrary policies of the bank. The present invention provides different options for extraction of data from accounts that are registered in the financial institution which is not connected or does not integrate the platform 110. Thus, instances where the transactional data is made publicly by the system includes transactions where no electronic transmission exists between a publisher and financial institution and reliability of such date is provided by storage within the system.

The first option is receiving bank account statement in the electronic form from a client of this bank. In this case the extraction of data from financial account and storage it in data repository 119 is not performed automatically. This bank account statement may be preprocessed and downloaded in the module for data storage 119 and further may be published. Preprocessing of bank account statement in the electronic form may include optical character recognition if the electronic form is the PDF, image or scan formats. Then some known data extraction techniques may be used to extract data from structured documents (the account statement is one of types of structured documents). Preliminary created rules may be involved in this process. Moreover third-party providers, which may extract transactional or other account data from a bank of a client may be used in the case when there is no agreement between the platform 110 and the financial institution 120 for transmitting data about the performed transaction or other activities with the account.

The financial institution 120 may integrate the module for publication of transaction data 113 of the platform 110 internally. m this case, social activity is performed on the side of the platform 110 with usage of GUI and module for social networking and collaborations 115. For example, the platform of publication of transactions may be implemented in the service of online banking 122 of any financial institution. In such cases the financial institution 120 may use the platform 110 for publication of financial data of a client created an open accounts the platform 110. Moreover the financial institution may integrate all the functionality of the platform 110.

Referring to FIG. 1AA the platform 110 suggests different modules for providing the interaction between the users or clients 130. Some of such modules are GUI 118, module for registration a user (111), module for management a profile of registered in the system user 112, module for social networking and collaborations (115) of users, module for publication of transaction 113; module of account management 114, API module 117; module for storage data (119 about transactions and activities with the system. Interacting of the user with the platform may be performed for example through the mobile application or through the website.

Namely, a module for management of a profile 112 of registered in the system user/or bank account holder may provide opportunities for changing profile information of the user\client. The profile 12 will be described in more detail below.

A module for social networking and collaborations (115 is designed for commenting published transactions, rating (or evaluate) them such as for example, “like”/“trust” or to “dislike”/“doubt” them, share comments or transactions with other users. Also this module may be used for tracking accounts of other clients, joining evaluations and comments of other users/clients, joining to communities of interesting accounts, etc.

The module for storage data 119 (or in other words, data repository module) regarding transactions and activities of users or clients collects the information about the user/clients, about their profiles, about accounts, completed or planned transactions, or in other words all data about activity of the user. This module is also responsible for storage of all information about details of transaction that was received from the financial institutions 120. Module for storage data 119 within the platform may comprise at least one computer-based systems or servers, wherein the computer-based system or server has at least one processor unit, memory unit, and data-storage unit, wherein at least one computer-based system electronically communicates with remote, processor-controlled user devices or other computer-based systems through a communications environment, such as the GUI of a mobile application or website.

Moreover, the platform 110 allows user/clients access to the stored data in data repository module 119 and provides opportunities to generate reports with analytics tools. For example, a user may generate reports or charts based on statistics of published transactions.

Referring to FIG. 1AA financial institution 120 which is connected to the platform 110 or has the integrated platform in the system of an online banking system 122 having different tools for interacting user/client with accounts. For example, online banking systems 122 of a financial institution 120 may comprise a module for registration (opening) a (transaction/bank/checking) account 121, a module for bank account management 123, wherein the module for account management may include transaction module 125 for processing performed financial transactions, API module 127.

Purpose of API module 127 of the financial institution 120 is providing connection with API module 117 of the platform, exchanging files and commands between the platform and financial institution, sending notifications, etc. The module for registration (opening) a (transaction/bank/checking) account 121 may allow to open a classical account in the financial institution. Module for bank account management 123 may allow to perform classical financial activity with the account, for example make transaction, receive bank statement, receiving donations, making payments, etc. Management of the account may also be performed directly by using the platform with the module for management of a profile (112).

FIG. 1B is a method of interacting a user/client with the system of the invention. The platform 110 may have a GUI of web interface 151 that provides the user\client an opportunity to interact with the platform. User's web browser or mobile applications in processor-controlled user devices 151 and remote servers 159 of the platform 110 exchange the information. Electronic communications between computer systems generally comprises packets of information, referred to as datagrams, transferred from processor-controlled user devices 151 to remote server computers 159 and from server computers to processor-controlled user device 151. In comparison to other known electronic communications the current interacting a user/client with the system of the invention involves the adding and storing the information about the counterparties of transaction within the system in such way that this information can be published. In one embodiment, a hash chain provides the transparency of the transaction data. When the data about the particular transaction is transmitted to the data repository of the platform, the transaction receives a hash. Each subsequent transaction within the system also stores the history of the present transaction wherein it was involved, forming the hash chain. Accordingly, the best chain consists of the longest series of transaction records. As a consequence every transaction data may be checked within the present system. All modifications in the transaction data are transparent and may be published, inspected or analyzed.

Any person or organization may interact with the system of invention. Person may become a client of the system to publish transactions in his or her own personal goals. Both public and commercial organizations may be interested in the interacting with the system by opening transparent account and becoming the clients to rise trust level and attract new customers.

Referring to FIG. 1B a person or organization interacting with the system of invention is represented. As was mentioned above, by “user” we mean any person (or organization) who interacts with the system. User may be registered in the system and have a dedicated profile. User may be unregistered. Information that is gathered from users/or clients through the web interface 151 or bank account data that received from banks 120 is stored in the data repository 119 within the servers 159

Referring to FIG. 1B interacting with the system person or organization may be an investor 151, sponsor 152, account holder 153, donors 156 or contributors 157 who donates or deposits money to an account 159. This account may be located at a bank 120 or other financial institution that is interconnected with the platform 110 for publication information of transactions. Any user (registered user or unregistered guest) 155 of a system of invention may access to published information about account. For example, the user may be an auditor who accesses information about donors 151-157 and recipients 156. An owner of account may perform any outgoing transactions. For example the owner may transfer available money to any other internal or external accounts 156. The term “internal account” may refer to any account that was registered in the platform 110. The term “external account” may refer to any account that is opened into an external bank not connected to the platform. Any account that receives money is a recipient 156.

FIG. 1C is a method of publishing a transaction wherein an account holder initiates and performs any payment 170c, for example, by credit. At the step 171c the information about the performed transaction is automatically transferred to the bank 120 that issued this card. The information about the performed transaction is downloaded 172c from the bank 120 by server 159, for example at the end of the day when the transaction was performed. The downloaded information is processed 173c by server 159 of platform 110. The processed and extracted information is saved 174c in database 119 of platform 110. The account holder may provide 175c the additional information about the transaction. For example, the account holder may entitle the transaction and provide it with the description. This step is optional and may be skipped. The information about the performed transaction is published 176c and is available for viewing and commenting to all users.

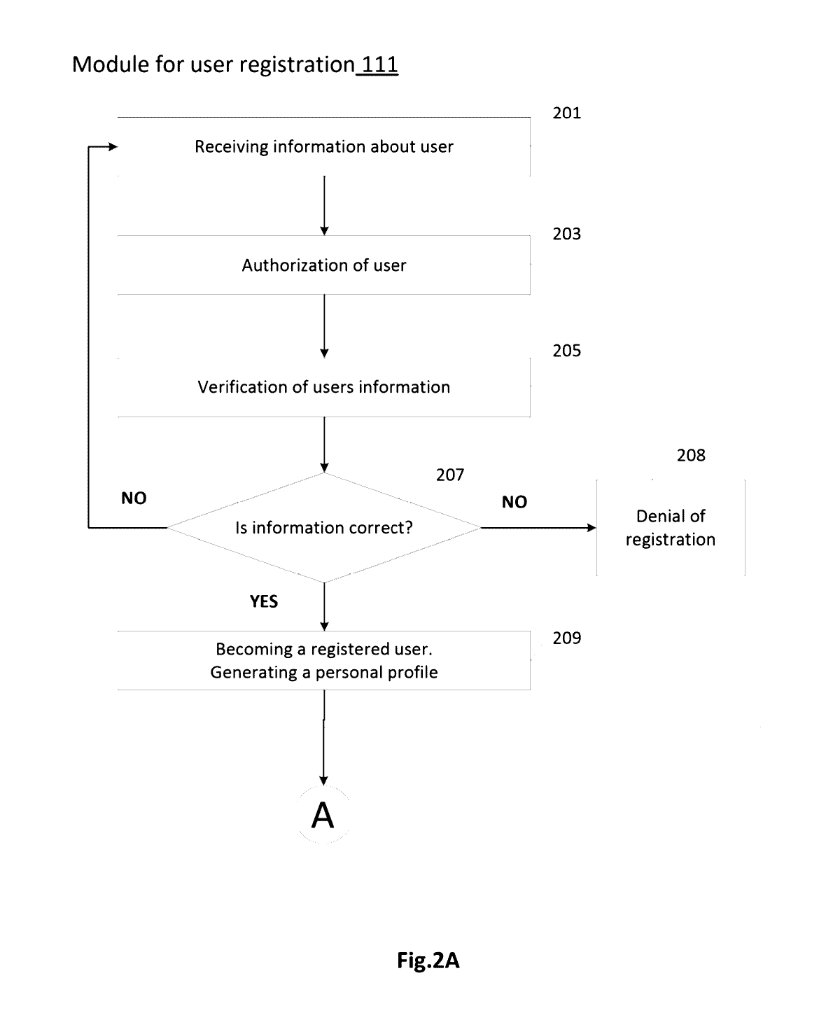

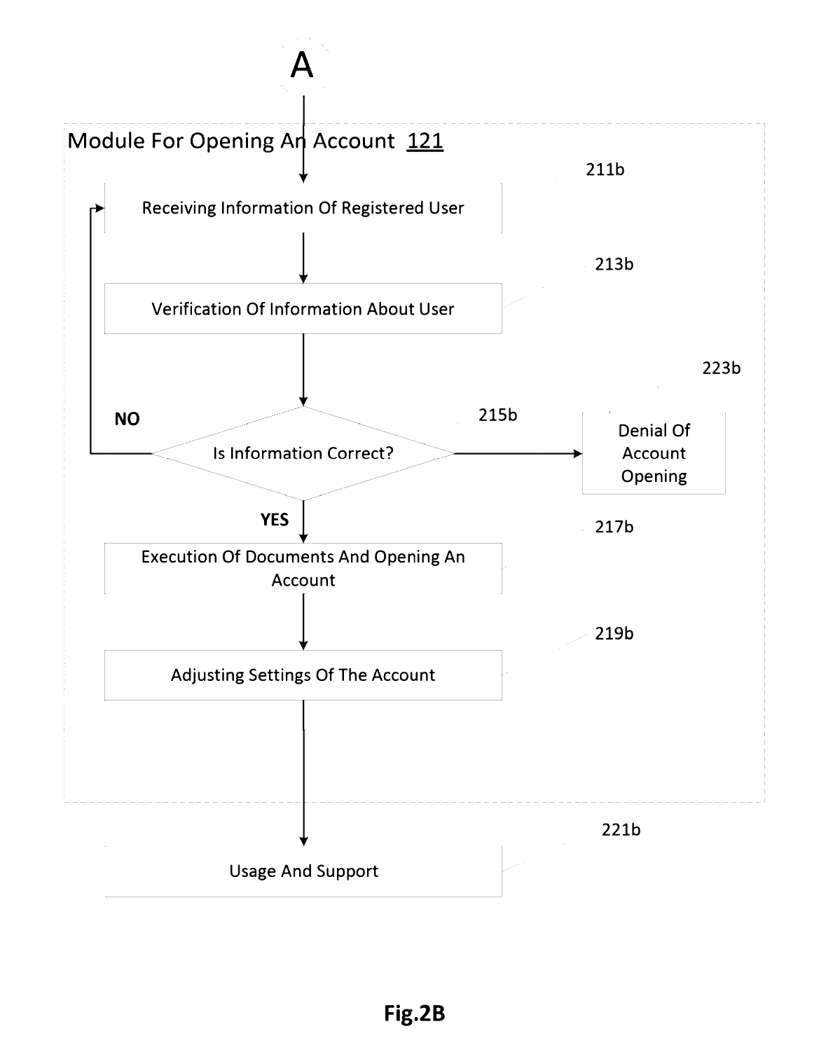

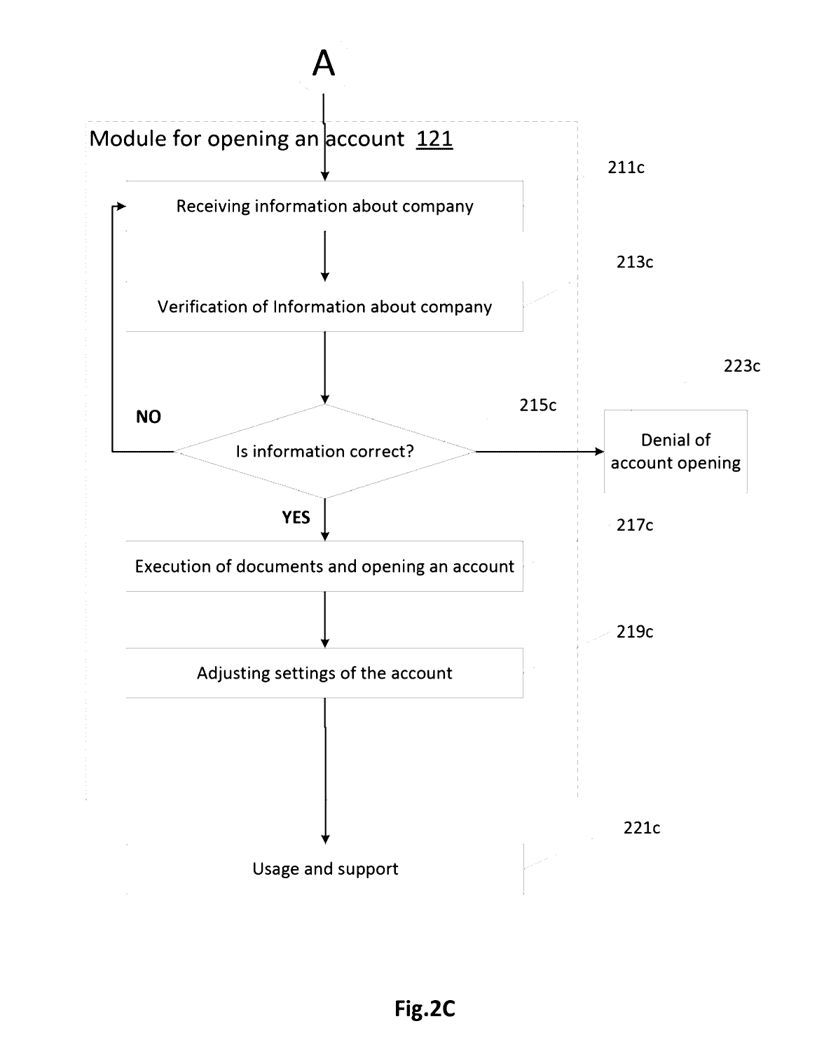

FIG. 2A is a module for user registration 111 within the platform 110 that registers a new user in the system. Registration in the system may be performed. Within the context of the present invention, registration relies on verification tools and independent sources of information to reliably identify users and clients are both. Supplemental sources of information may also be provided as a threshold to permit access to the system Access to the system is enabled through the GUI of an internet browser or through the mobile application in processor-controlled user devices or other computer-based systems.

Referring to FIG. 2A, at the initial step 201 personal data from a user is received. The requested data may comprise phone number, profiles in social networks (Facebook®, Google+®, Twitter®, LinkedIn®, etc), first name, last name, date of birth, email, residence or mailing addresses, etc. Personal information including, for example, a photo of the user may be extracted automatically from specified internet resources, such as profiles in the social networks. Documents (passport, driver license or something else) may be also provided during the registration. The images of requested documents may be downloaded in the system through the input devices, such as camera of mobile phones. The images of documents may be processed by Optical Character Recognition (OCR) systems to extract data into structured form. The list of requested for registration information is illustrative and does not limit the scope of the present invention. Then 203 the authorization step for the user is performed.

At the next step 205 the verification of information about the user is performed. Different sources of information to verify may be used here, including information extracted from special governmental or private databases. If the verification step 207 establishes that the information about the person is correct, that person becomes a registered user of the system (209).

At step 209 the registered user also gains an access to a system generated personal profile. A generated profile of the registered user may include provided personal information. Once registered, the user profile may be managed by the user Module for profile management (112, FIG. 1AA Registered users are responsible for changing or adjusting settings of their own user profile information and accounts that are further connected to the profile of the client. All modification of information in the profile is verified. A registered user becomes a client of the system after the account is opened by the registered user. If the provided information is not correct or incomplete, the system requests corrections and, or additional information at step 201, possibly resulting in denial (208) of registration.

When the registered user of the system wishes to open an account, the user chooses a type of the account to be opened, for example an account for crowd funding, for social non-profit organization, corporate or personal. An account in the financial institution 120 may be opened (or registered) directly through the platform 110 by module 114.

The account for a crowdfunding project, for example from IndieGoGo®, RocketHub®, GoFundMe®, Brigade®, is purposed for gathering and spending money for a specific project. Registration from the partner side will be described further. Non-profit social organizations (such as Wikipedia®) also may be interested in opening a transparent account with an opportunity to publish all transactions for efficient management of public money. A corporate account is purposed for tracking financial activity of organization. All users of the system, for example employees of the organization are able to review and control the transactions. A personal account is similar to a classic bank account but with an opportunity to publish all information.

### Account for Personal Goals:

Referring to FIG. 2A, the utility of the module for user registration 111 is shown in the context of the process wherein a user is being registered 209. In the process, information is received about a user 201, the user is authorized 203 and verification of the user's information is performed 205. Upon a verification step were in 207, the registration and generation of the user profile can be completed 209. Verification of the information occurs in a loop wherein failure to provide correct information results in denial of registration 208 or re-initiation of the process of module 111 through receiving information about the user 201. Once correct information is complete and verified, a personal profile is generated 209. The profile 209 so generated is a personal page in the online system with detailed information about the person, wherein the person may be a user or client, i.e. transparent account holder. A profile that is generated in this step 209 comprises an individual or a company or project. A page with personal information, including but not limited to, details about the profile 209 in the social network, published information about the current job place or university, organization etc. Publicly available information is aggregated from open sources from the Internet, such as Facebook, LinkedIn and so one. A module for profile management 112 is purposed for creating and modifying the profile.

FIG. 2B is the method of opening an account for personal goals. At step 211b, additional or absent information of the registered user is received. Then, the received information is verified at the next step 213b. If the information is correct 215b, documents are executed and an account is opened 217b. Also adjusting of account settings 219b may be made at any time after opening the account. If the information is not correct, the denial of account opening may be received 223b or additional information may requested and received regarding the registered user 211b.

### Account for Organization:

FIG. 2C is a method of registration of an account for an organization.

Referring to the FIG. 2C, block 121 illustrates the procedure of opening an account for an organization. In the case of opening a corporate account or account for a non-profit social organization or for a crowdfunding project, the information about the organization is requested at step 211c. Opening of the account is performed by person, namely by the registered user. A profile of the client may also be connected with the account of organization. Additional information may be downloaded and gathered through both the public sources on the Internet and private or governmental databases. A profile of the organization in a social network site may be also connected to the account. Next at the company information verification step 213c, the verification of the provided information is performed. If at step 215c the information about organization is correct, documents and agreements may be signed at a document execution step 217c and the account will be considered to be opened. If the provided information is not correct or incomplete, the system requests correct or additional information at a receiving information step 211c. Also, a denial 216c of registration may be received by user which forecloses opening of the account. Further the adjustment of profile settings may be made for the account. A module for account management in financial institution 123 and 114 may be used by the client (account holder).

### Account for Project.

Another variant of registration is registration through a partner, for example through the web site of a partner. The term “partner” will refer to the organization that may be connected with the platform by example, an agreement to approve the data adequacy of a project. A partner is typically an external organization, such as a crowdfunding platform, project funds or non-profit organization. The term partner may refer to any money raising organization. A partner may have one or more projects, wherein the goal of the project is a deal for which funds are collected. Crowdfunding is the practice of funding a project or venture by raising monetary contributions from a large number of people, typically via the internet. Information about the project and the aim of raising money is usually represented on the website of the partner, for example on the website of a crowdfunding platform. The aim of crowdfunding is raising money and the transparency in financial reporting, together with the ability to track the financial transaction within the project, which is especially important for donors. Transparency in financial activity attracts more money to the project.

A person or organization interested in publishing a report of spending money within a project may create an account registered in the platform 110, to provide an opportunity to publish the information connected with financial transactions. The method of registration will be represented bellow.

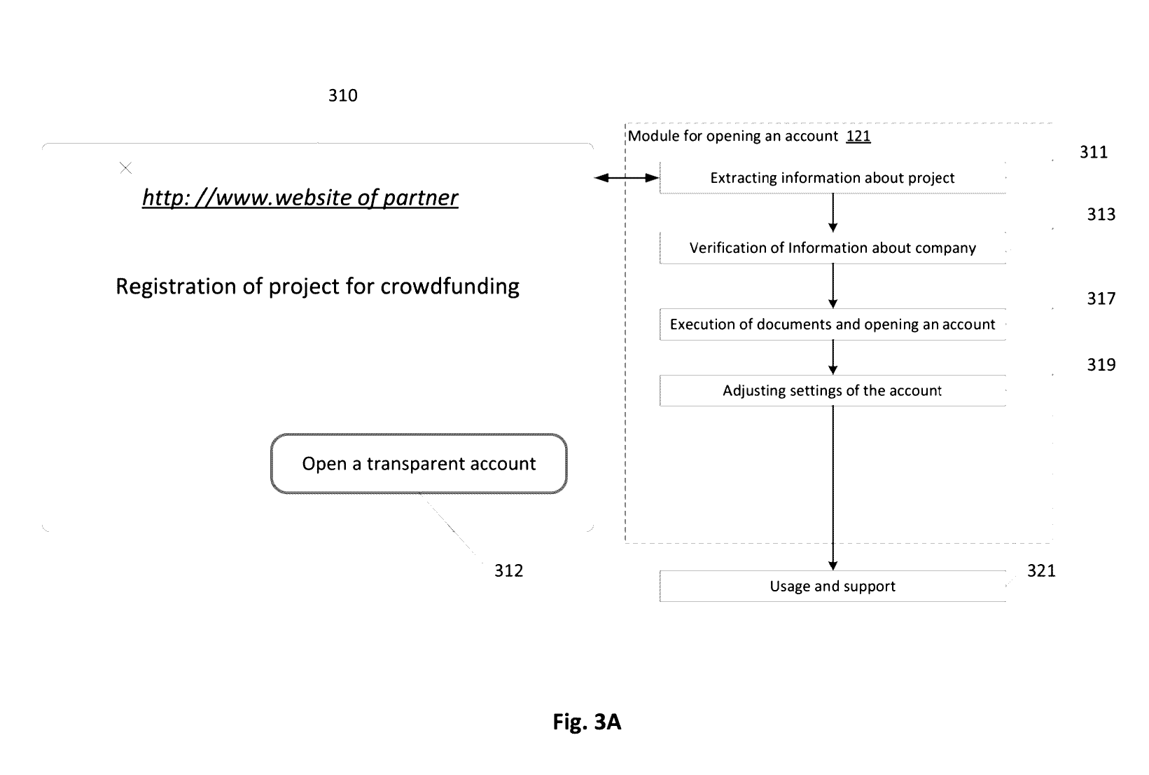

The scheme of registration of an account in the platform 110 through the site of a partner is depicted in FIG. 3A. For an account to be opened for crowdfunding projects the all the necessary information about an organization and a project may be automatically extracted 311 from the web site of the partner 310. The website may contain some indicator or button or link to open a transparent account 312. This link may transfer a user to the module for opening an account 121 and provides an opportunity to register the transparent bank account for the project. The step of data verification 313 about the project and organization may be partially skipped. It is considered that the information from partner sites is reliable. The module for opening an account comprises of the step of extracting information from the web site of partner 311, verification of the provided information 313, execution of documents, opening an account 317, and adjusting settings of the account 319. Further the usage and support of the account is maintained 321.

As mentioned above, the open account (personal in FIG. 2B, corporate in FIG. 2C, or project in FIG. 3A) may have an account holder responsible for account operations. The profile of the account holder may be connected to the account, and the account holder may perform a management of account by account management modules 123 or 114.

### Profile of a User in the System of Invention.

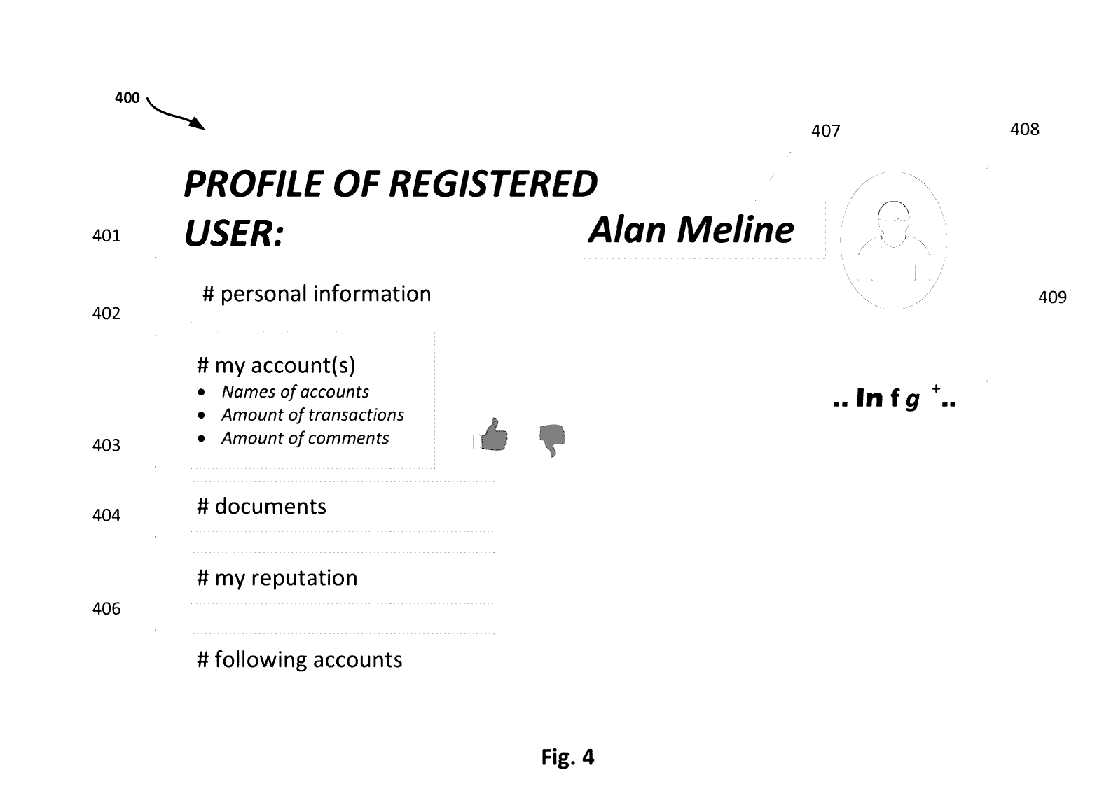

An illustrative profile of registered user (or client) in the described system is depicted in FIG. 4. FIG. 4 is a profile of the registered user or client, namely the page (for example in the browser) in the system with detailed information about the person. Users enter data, such as personal information 401 about themselves 201, FIG. 1. The personal information 41 of the user (guest) may be not verified in contrast to client's personal information. The browser (or application) page may include: personal information, social information, information about accounts, and profile of an organization which account is supported by this user. Personal information 401 may include full real name of a user (for example Alan Meline 407), photo(s) 408, links 409 to profiles in social networks (such as Facebook®, Google+®, Twitter®. LinkedIn®, etc). Links to profiles in social networks may be used for data extraction as a reliable source of information about everyday social activity of a person, such as reputation 404 his/her friends, his/her openness, etc. Common friends in the social network may form an opinion and primary trust of other users based on a connection to this particular person through any connection, or particularly through following accounts 406. Also additional information about the person may be represented here, such as information about job, activity in life, achievements. A person also has an opportunity to download documents 403 that confirm the personality profile holder. Every piece of reliable information about person increases the level of trust of the profile.

In addition to social information the profile may include an indicator of reputation 404 in the system. The indicator of reputation 404 shows an overall assessment or level of approval by the user of the merits of any data point, including the reputation 404 or other indications of merit in the system. Moreover, details of how and for what a user received the reputation 404 grades may be reviewed. Indicators of reputation 404 of a particular user is a function that is calculated automatically based on key factors of user activity in the system. For example, key factors are how ratings (or evaluations) of transactions are supported by other users (or clients), including both positive and negative factors whether he was caught in the flood (multiple dislikes, rude comments) and so on. Moreover the social information in user's profile may include overall statistics about account and activity, number of disputes, etc.

Information about accounts 402 may include names of accounts, amount of transactions (including the donations and deposits into crowdfunding), and amount of comments about transactions. A module of management of profile 123 allows following of other profiles and accounts. The information about users who track any accounts is also available for reviewing. The information about donations, contributions or investment made by users may be available for reviewing. Information about accounts that are followed by a profile holder is also available and public. Adjustments in the profile details may be made by a person with help of the module for profile management 112.

A profile of the client, i.e. of the registered user, may contain additional information about a management of the account by this particular person. This additional information may include list of all accounts with the overall sum of money, infographics with rating (evaluations), title of the possible projects, how many people discuss this idea and what average value (rating) is. For example, money for a crowd funded project or non-profit organization is collected by escrow. If the amount claimed for the project is collected, the money sent to the account, if not, the project did not take place and escrow sends them back to contributors.

In addition to the profile of a person, there is a possibility to create the profile for a company. A profile of the company may have a corporate account. Company may have a list of its accounts. Some clients, i.e. registered users with account privileges, manage the profile of the company in the system. A profile of a company may have the following information: title of a company, business organization, bank information (account identification number), field of activity, number of registered users, who are related to the company, projects (with the description of a project), overall description of a projects, contact information, profiles in social networks, number of followers within the platform, ratings of users (or clients), number of opened transparent accounts, balance of accounts and time of registration within the platform.

The system allows attachment of information about the previously completed transactions to the profile of a user or client. For example, a user who provides a donation to the Red Cross, where the Red Cross is connected to the platform 110, yields detailed information about this particular donation. If the user of the platform has the profile in the system, and wishes to publish the information about the completed donation, he or she may add the information about the card (or account) from which the donation was completed to the profile. The system may automatically identify all transactions of this particular card (account), and publish all identified transactions to other users.

### Dashboard:

One of the main features of the described system is an opportunity to follow an account or accounts of other clients in the system. Any guest of the system may view information about an account of interest. Any (registered) user of the system may also subscribe to the account of the client and follow the account. Tools for collecting the information about all accounts, transactions, tasks and evaluations of a particular user may be assembled and displayed in a dashboard. A dashboard is especially useful for performing an analysis or generating different kinds of reports.

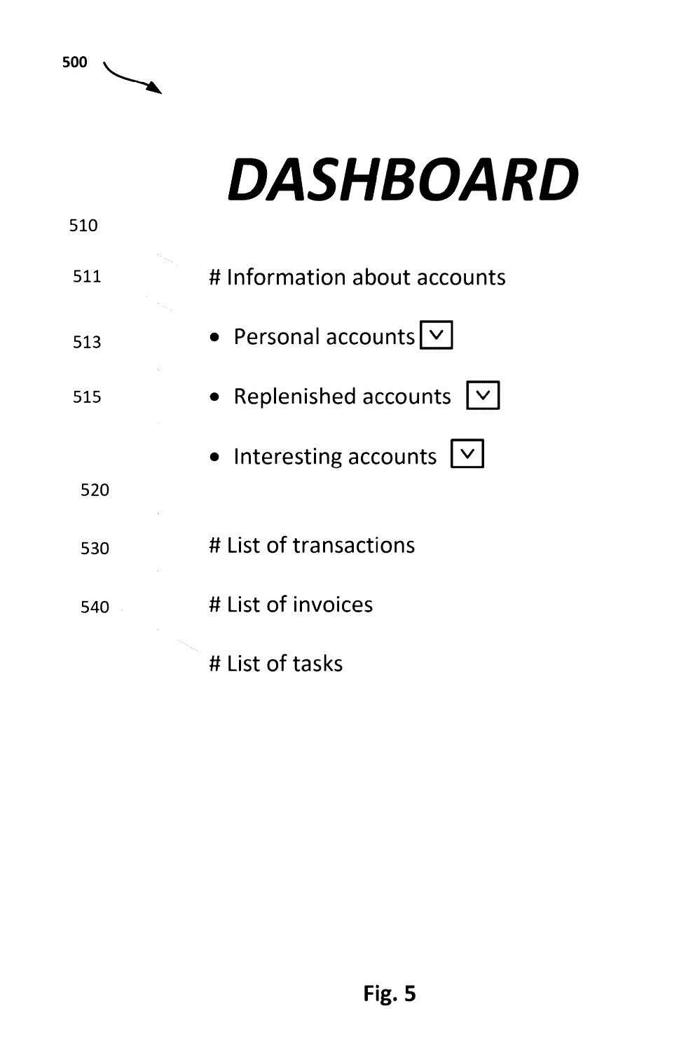

FIG. 5 is a dashboard 500 comprising a customizable screen that compactly and visually displays vital information on different aspects of the system. For example, dashboard 500 may allow assembly and represent the news feeds or activity feeds for displaying news of followed users/clients. The dashboard 500 collects and represents the most important information, more particularly information about all accounts 510, information about transactions 520, information about tasks 540, information about payment invoices within the system 530, and evaluations that are related to a particularly user. All transactions are optionally available to be evaluated by all users/clients. For example, a user may receive a task to evaluate the transaction of any particular account that he\she follows.

Information about all accounts 510 of a user comprise the list of personal accounts 511 of the user (title, balance of account, most important notifications related to account, for example the most negative evaluations and comments); a list of accounts that were replenished or donated by user 513 (the total amount of donations and the used part of the donation), a list of accounts that are interesting for the user (followed by user) 515, and money within the bank 120 that may be tracked with the known proof-of-records method. Currency or any monetary unit is linked to a person, such that the history of moving money is also public. Other technologies allowing access to full information about money movement. Due to the fact that the moving of money within the system may be tracked a client/user, the user may view and assess how money is used or should be used by recipients of donations as long as the recipient of the donation is registered in the system and has at least one account.

A list of transactions 520 contains information about payments of the user to the account(s) within the system. Each transaction (payment) is provided with information about further usage of the money in transactions by other accounts and users. Activating this feature provides subsequent detailed information about the current transaction and the user may receive detailed information about usage of individually or collectively donated money. This opportunity is supported by the fact that money tracked within the system has stored records and a history of transactions within the system.

A list of tasks 540 contains data about the task of a user, such as the level of readiness and an assessment of the value or quality of execution of the task (jobs) by an entity. The value of execution of the task (jobs) is calculated based on the comments of the entire community who has access to an account and can evaluate any transaction that is assigned by user. For example, if a community supports the user's (client's) evaluation, the rate of user\client in the system rises based on these evaluations and can be quantitated as a personal characteristic up to the level of an expert.

### Account

The system of the invention provides much more information than is typically provided under normal banking secrecy practice. By user agreement pursuant to the invention, at least the following information is may be published: title of account, date of opening, details of funds flow for all the time and the current balance: information about account holder—name, which he or she indicated at the step of registration, related profiles in the social networks, photos, and an indicator of reputation in the system.

The system also provides users tools to disclose additional information regarding the user and the organization. Each account has a description with image and text, where users can learn about the account of any selected project. This option includes an opportunity to view the information of the projects that were realized by this particular client and based on the history of recent project(s) to evaluate the experience of any client who lead the project. The account holder can describe its purpose is in details with images, videos and external links, and any additional information to increase trust of user to an account.

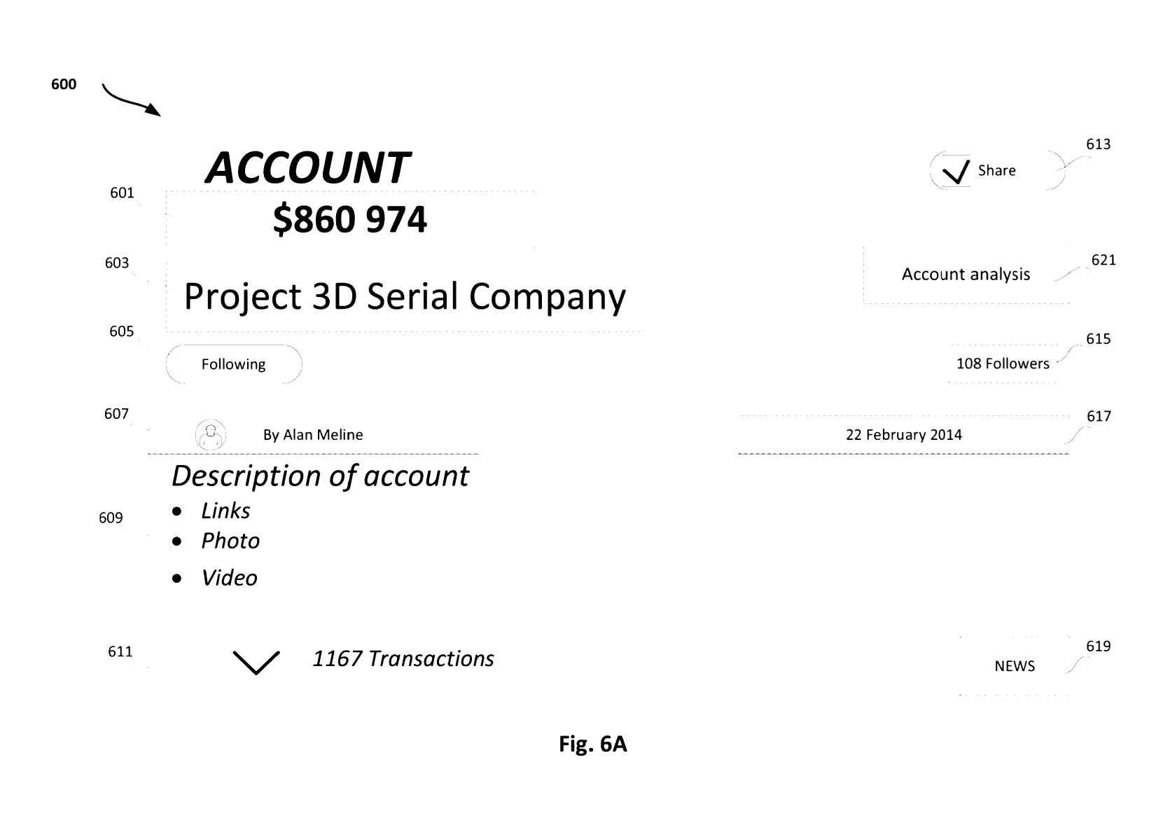

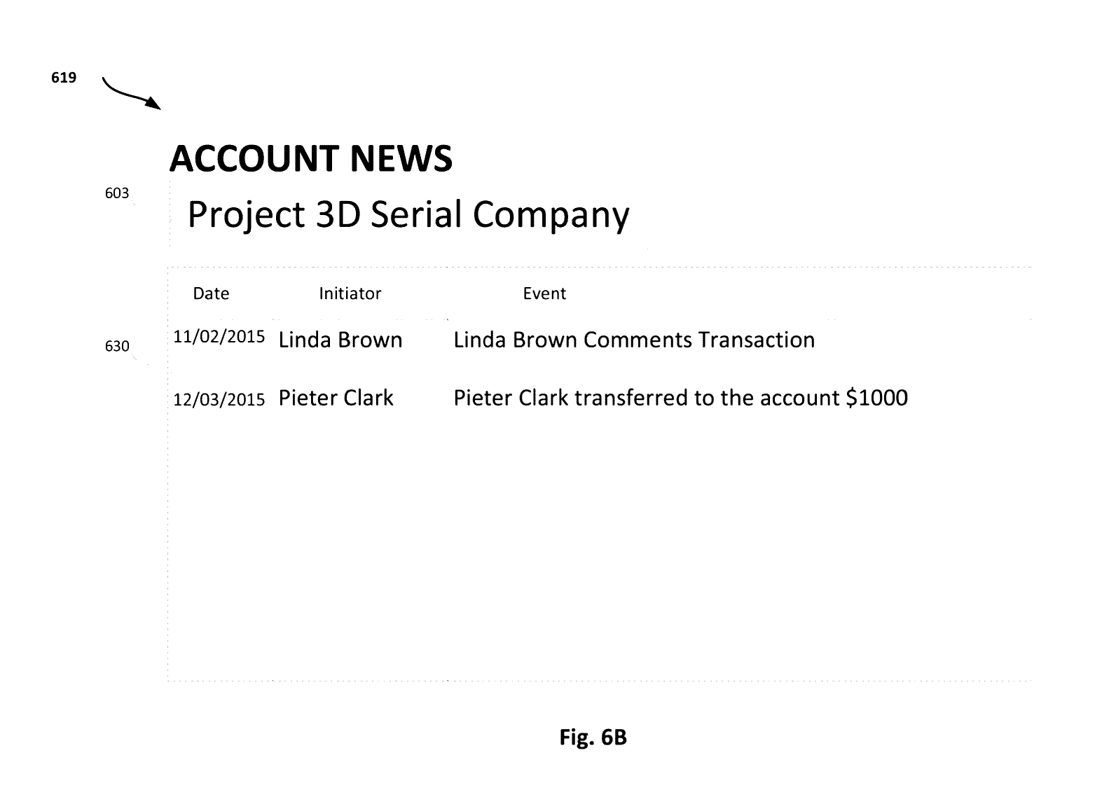

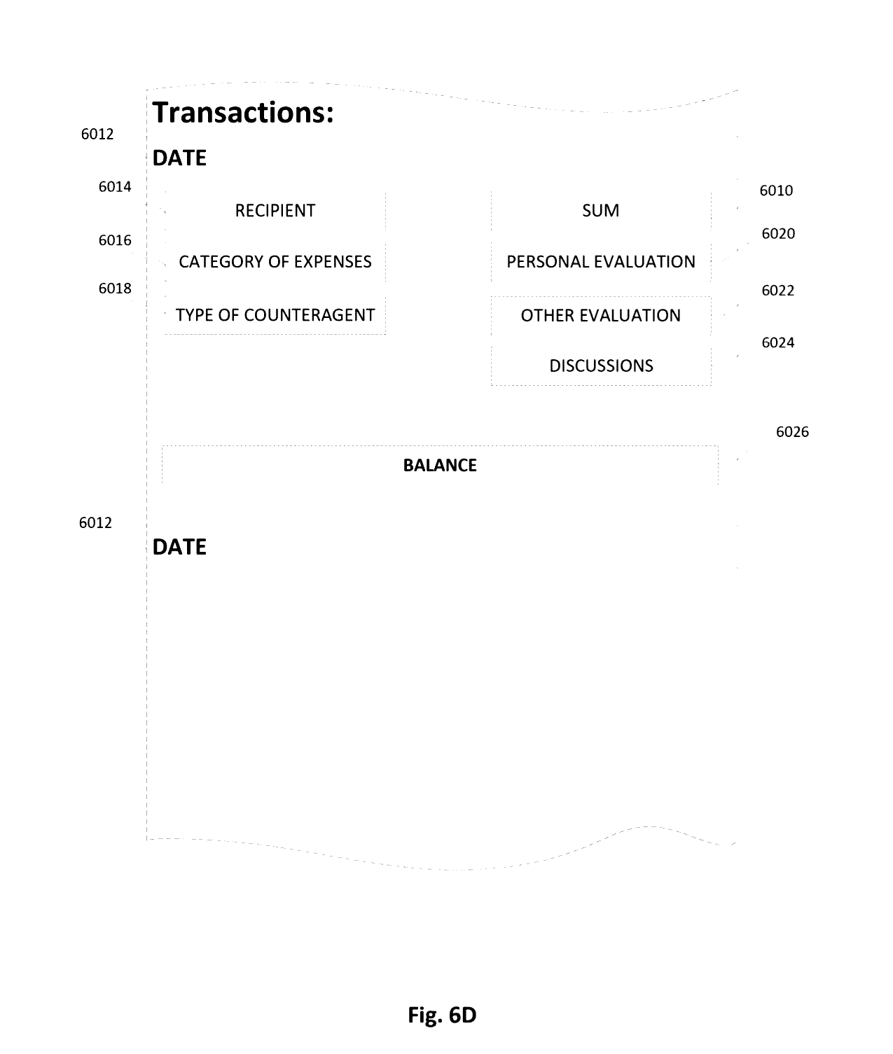

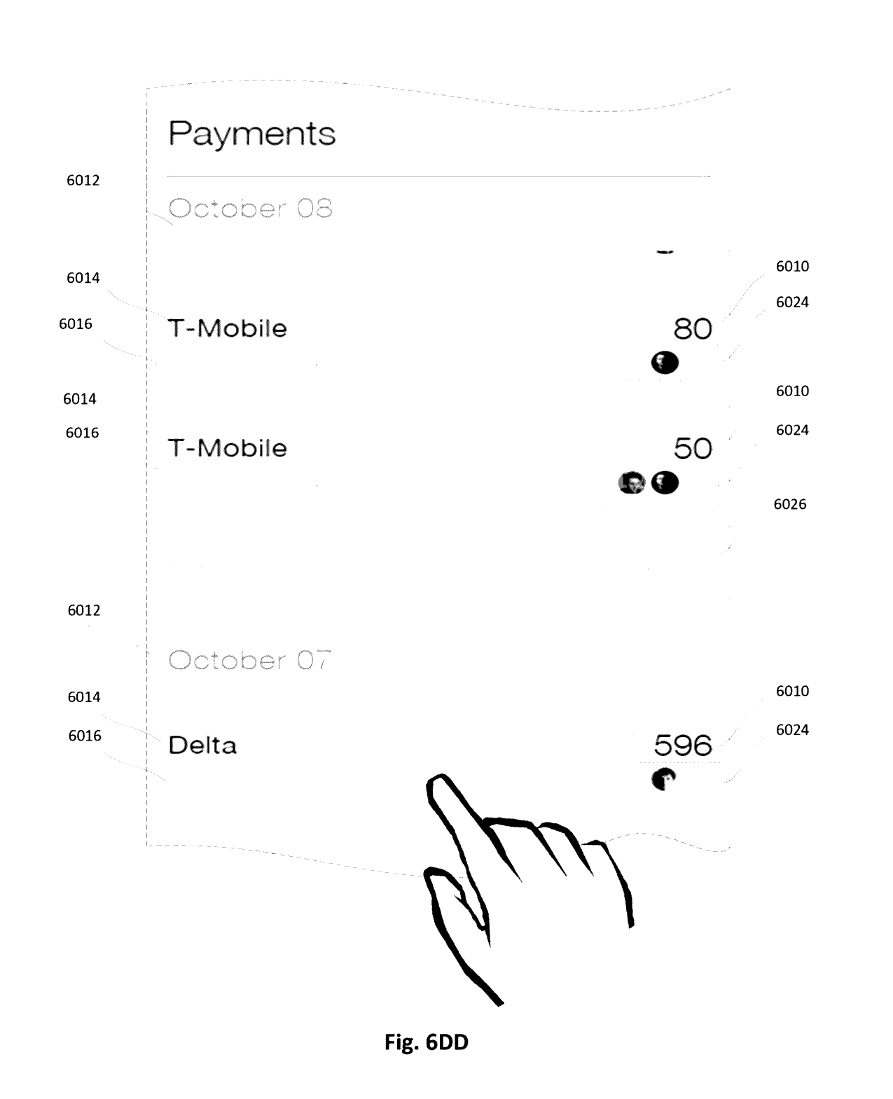

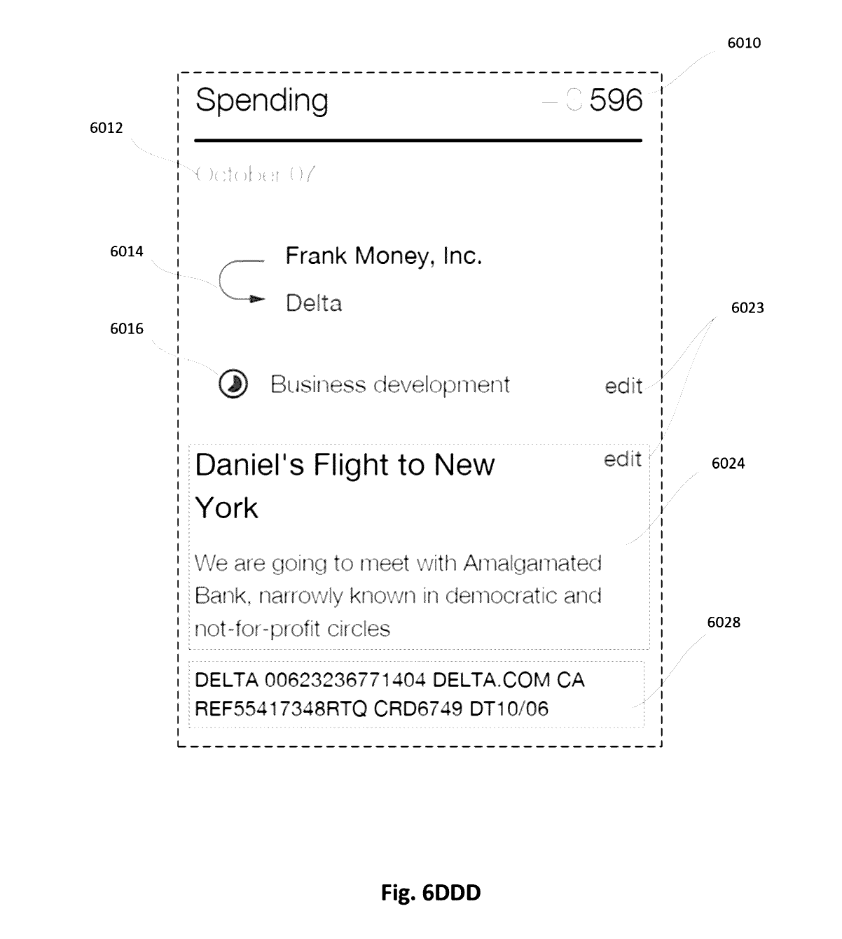

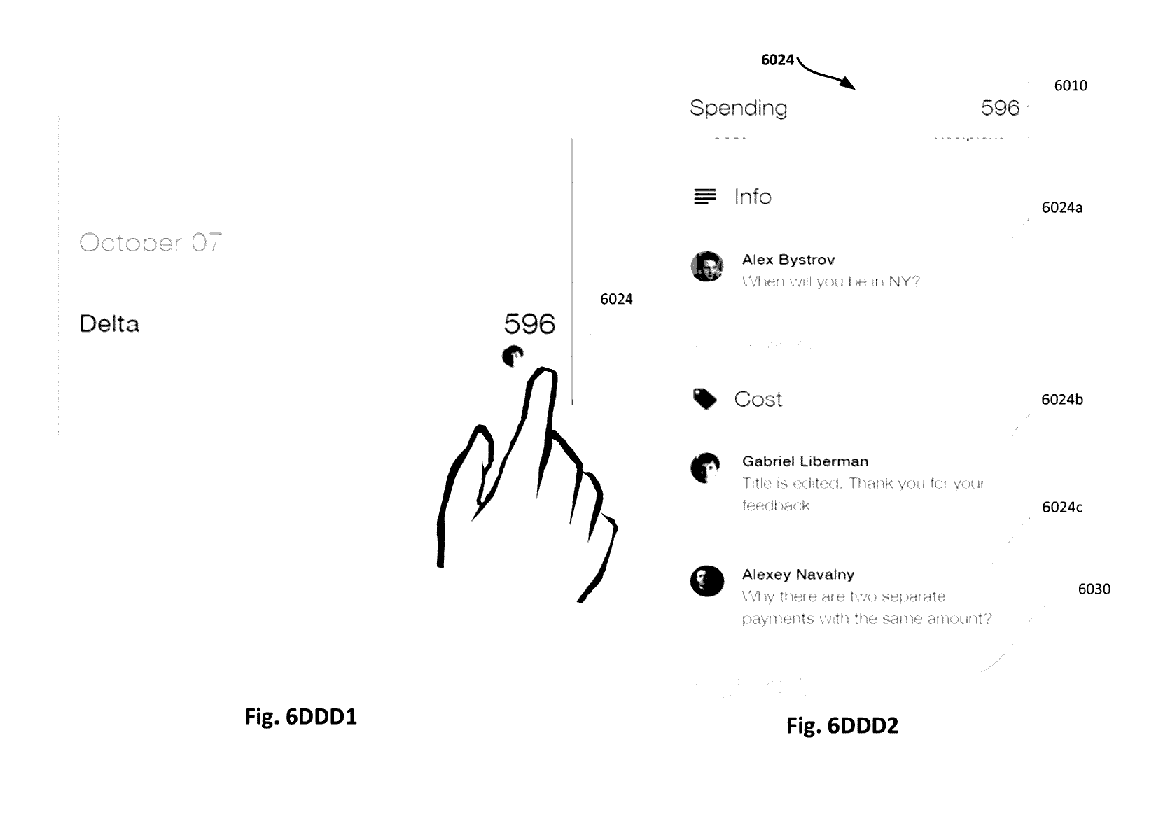

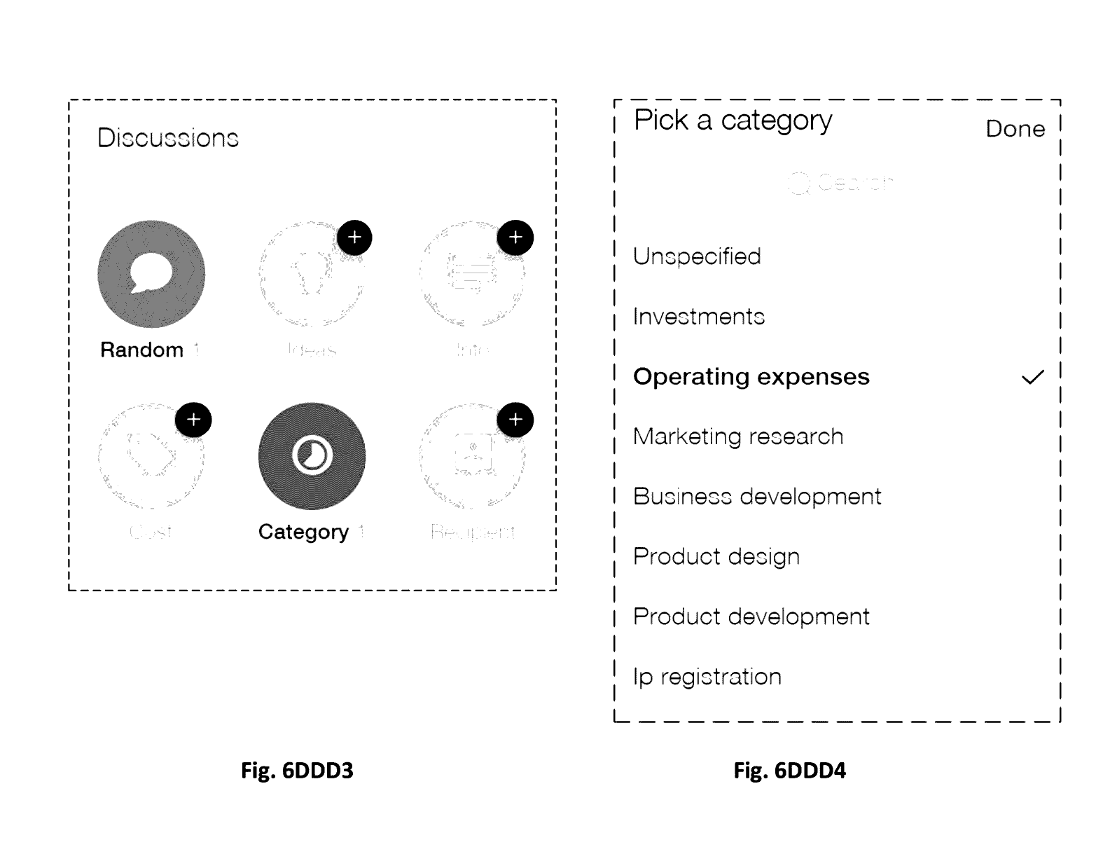

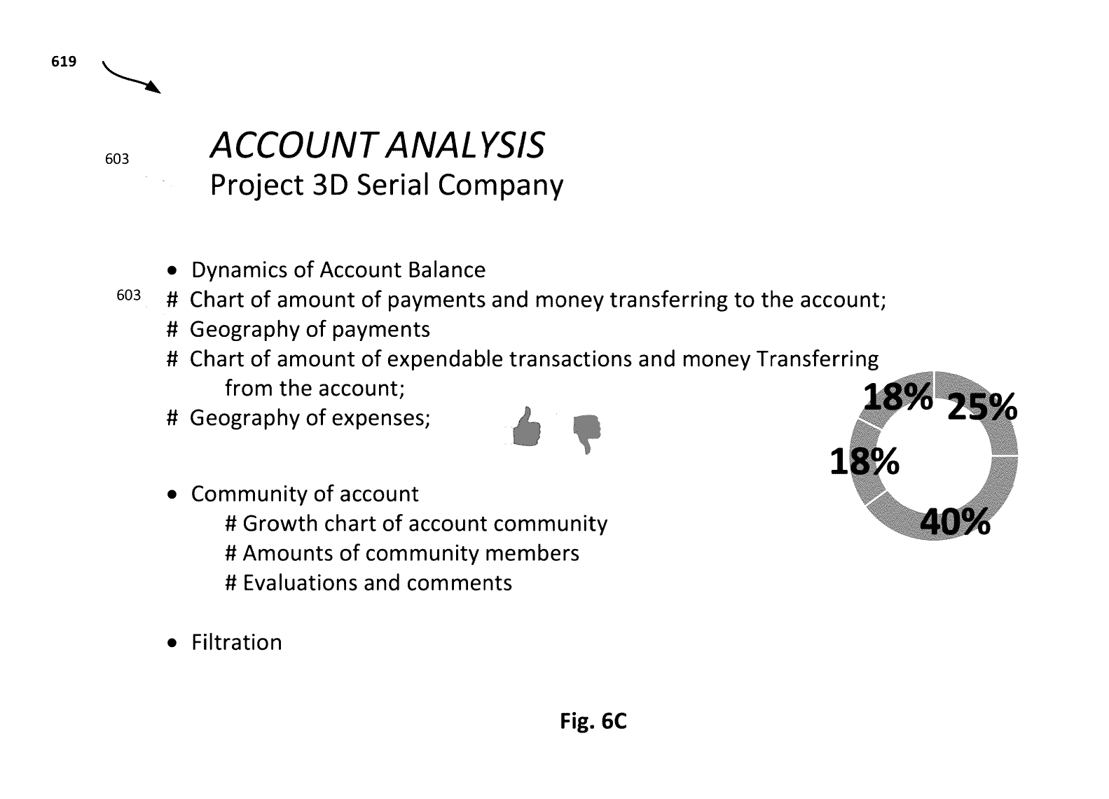

FIGS. 6A-6B illustrate a browser page 600 with account information displayed by a web browser running on a processed-controlled user device, and numerous features provided by the browser page 600. The browser page is generally the initial page requested and rendered for display by a user's web browser when the user directs the web browser to access the system. Commonly, users input a click to a displayed hyperlink or select a link from displayed bookmarked links in order to direct the web browser to the system.

In one implementation, as was mentioned above, the account in the system may be personal, corporate or specific. However, other types of accounts may be provided, for example family accounts or organizational accounts.

A “personal account” is opened by a client for usage in personal goals. A personal account is a consumer bank account that is fully transparent for other users. For example, a particular client may wish to share information about his/her transactions with a defined group of users clients or individuals the personal goal may be a target such as a solicitation of money for a personal medical treatment needed by the client. Every person who wishes to donate some money to the client's personal treatment may transfer money to the specified personal account and view all transactions from this account at any time. Thus, the level of trust to this account may rise and client may have the opportunity to receive more money for the treatment deposited in the personal account.

A Corporate account is purposed for tracking financial activity of for-profit or non-profit organizations. All users of the system, for example employees or business partners of this organization, are able to review and control the transactions, comment on transactions, rate and provide other analytical input that is recorded and displayed by the system. The corporate account typically has a dedicated account holder having a separate profile in the system and attached to the corporate account. The corporate account holder is typically responsible for management of the corporate account

A specific account is connected for some project, wherein the project is a deal for which money are is collected. For example, a project may be devoted to charity, investments, political goals or any defined activity or goal. Crowdfunding is the practice of funding a project or venture by raising monetary contributions from a large number of people, typically via the internet. Information about the project, such as an aim of raising money, is usually represented on the special website of a partner, for example on the website of crowdfunding platform. The specific project account is linked with the personal profile of the account holder, who is responsible for management of the specific account.

In some cases a user may come to the account page via the shared information about a transaction or the account itself or by the direct link from friends. In such cases, the user may want to know more about the project (connected with an account) and will look for detailed information. The user may select a shared link in the browser page, and such links may refer the user to a transaction page, wherein transaction page (FIG. 6D) contains the information with the account's title and a description for the project (FIG. 6A). Or, such links may direct the user to an account page. If a corresponding project has a dedicated page on the web (in case of a partner's projects on a crowdfunding web site), there will be a link to that page that will be opened in the external browser. In another implementation, an opportunity exists to use embeds for representing all information within the page of the website of a particular crowd-funded project.

As noted above, FIG. 6A illustrates an example screen 600 with account information that may be presented by an interface in web browser. More particularly, FIG. 6A illustrates the example of a specific account. Published information about the account may comprises the following details: Title of Account 604, Balance of Account 601 Date of opening the account 617 Name of Account Holder 607 and/or number of Followers 615. In this example the title of the projective account is “Project 3DSerial Company” 603, balance of account 601 is 860974$, and the account holder is Alan Meline 607. Touching on the link with account holder the profile of 400 Alan Meline will be presented on the screen as is shown in FIG. 4.

Followers of the account utilizing the transparency and information access enabled by the invention form the community of the account. Any registered user of the system may subscribe to the account to become a member of this particular community and receive notifications about changes with the current account. Any registered user, including followers of an account, may comment on transactions, rate transactions, or share comments regarding transactions.

Corporate accounts may have additional details about the organization that have this particular corporate account, such as information about structures of the company, its founders, legal status, residence, former organizations, and/or number of employees, in any other aspect of corporate information.

Referring to FIG. 6A the description of account is a portion or field (609) of a screen 600 containing the account profile. The description may disclose the aim of the account. The account holder fills this field generally. A description of the account that was created for the project from the partner may be extracted from the partner site. The process of creating an account for a project from a partner site is illustrated in FIG. 3A. The description of the account may include text information, links, photos and videos.

Referring to FIG. 6A, the data about Transactions 611 within the given account is also public for all users who interact with the system. By touching the link with any of the transactions 611, any user is able to receive information about all outgoing transactions within the account. Incoming transactions also may be available for reviewing in likewise fashion

### Publishing of Data:

The system allow user to share all bank account information. The full data about all monetary transactions with account are been published through different sources such as web or mobile applications and an API in real time. API module 117 is integrated in the open platform 110.

Moreover an API module 117 may be a module for third party developers to build applications and reports for their own needs and tasks. For example, as was mentioned above any financial institution such as bank may integrated this API module, so their clients can create open accounts as well and publish bank account data. In another implementation rating agency of non-profit organization may receive data through the API (117) and generate reports and charts based on the received data.

FIG. 6D is an example of user information that is provided regarding a transaction. The information may include the following details: sum (in local currency, for example dollars) 6010, date 6012, name of the recipient 6014, category of expenses 6016, type of counteragent 6018, type of personal evaluation (positive/negative) 6020, discussions 6024, amounts of evaluations from other users of the system 6022, an overall value of evaluations. Moreover the updated balance information 6026 is represented. This list of transactions details is mainly illustrative. Example categories of additional items are expenses such as fundraising; rent; taxes; administrative costs; preproduction; modelling; printing; food and beverage; delivery, etc. Example types of counteragents are travel, food, auditor, etc.

FIG. 6DD illustrates a screenshot with information about transactions in a fixed period of time, namely on October 7 and October 8. In according to the published information in the represented period of time (6014) three payments were initiated and completed, namely 80$ (6010) was spent on T-Mobile (6014) in the category of Operating costs (6016) on October 8. One user commented on this transaction (6024). Also 505 was spent on T-Mobile (6014) in the category of Operating costs (6016) in this day, this transaction had three comments. (6024). The balance 107 on October 8 is 351$.

Using a touchscreen or link, the user can be directed to the screen with the detailed information about it. Detailed information may include full information about the sum of transaction, recipient of payments, namely complete bank information that comprise name of the recipient and the bank account number and the date of the account opening, profile in the described system with indicator of reputation, evaluation and comments of user, amount of evaluations of other users, average rating, the form purposed to value the transactions, form for commenting, and goal of the payment. Goal of payment may be indicated in the form of text comment which is attached to the payment. A text comment may contain the agreement number, title of paid goods or service, the period of time paid for the use of anything, and other information characterizing the appointment of money. Documents may be also attached to the current transaction. In one implementation, invoices may be attached automatically. For example, if the platform is connected to the special services, such as Quickbooks7), an invoice of clients, wherein the invoice has the same sum and beneficiary (recipient) of transaction within the platform, is attached automatically.

Illustrative detailed information about the transaction is depicted in FIG. 6DDD. In according to the information the transaction was performed in October7. The money was transferred from “Frank Money, Inc.” to “Delta”. The category of transaction 6016 is “Business Development”. Also the transaction may be changed, clicking on a display area “edit” 6023. For example, the category may be chosen from example categories illustrated in FIG. 6DDD4 which are Investments, Operating expenses, Marketing research, Business development, Product design, Product Development, IP registration, etc. The list of categories is illustrative and not exhaustive and may be expanded and adjusted for clients which interact with the system of invention. Returning to the FIG. 6DDD the client may add information about the performed transaction, for example the client may give the title to the transaction 6023, such as “Daniel's Flight to New York”. Moreover the client may comment about the transaction (6024). The financial details 6028 about the transaction are also represented.

Returning to the FIG. 6DD and FIG. 6DDD1, the sign discussions 6024 about the transactions are represented. Discussions include comments of users that are following the account and the performed with the certain account transactions and payments. In according to the represented example, 596$ were spend to Business development, namely the money were transferred to “Delta”. Below the amount of the spend sum of money the sign of four comments in discussion are illustrated. Touching of the display area with the discussion sign (FIG. 6DDD1, 6024) the user will be redirected to the screen with the tread of discussion. The tread of the discussion is illustrated in FIG. 6DDD2. In one embodiment, there are six categories of comments (FIG. 6DDD3): Random, Ideas, Info, Cost, Category1, and Recipient. So returning to the FIG. 6DDD2 Alex Bystrov left the comment 6024a in the category Info 6 days ago: “When will you be in NY?”. Also there are two comments in category “Cost” 6024b and 6024c. As was mentioned, any user of the system of invention can join the conversation 6030 and leave an opinion about the performed transaction.

### “Spending Rating”

Another primary feature of transparent accounts provided by the invention the ability to track the transactions by or for public audit. By accessing the system and selecting the appropriate tab/link, any user may track money spending and rate any transaction.

In one embodiment a user/client rates transactions from a client/partner site. For example, a guest may come to the project page, wherein the project page is the page on the web site of a crowd-funded project or non-profit organization, wherein, near the collected amount (sum) of money or the balance, which can be determined by activities, there is an icon The icon is an indicator that the account is transparent and the information about all money, income and spending is public. The icon may link the project page on the partner web site with the account page within the system of invention. A user may click the icon and go to the account page in within the system.

In other embodiment, information about an account may be placed within the website page of a project.

In another embodiment, a user may rate the transaction within the dashboard of the system. In user's dashboard, a registered user may see a list of accounts which the user payed into and which the user follows so that any number of user-initiated transactions may be monitored or displayed. By clicking on the corresponding account, the user goes to the designated account page. Any user may also use an embedded searching function to find out the information about a user account or profile of a user/client.

On any account page, a list of all account transactions appears with short information about each one and each is provided with short statistics. By clicking on the transaction rating area, the user can see more detailed information about any transaction and a pop-out field is available for choosing a rating for the transaction.

### Transaction Rating

Rating of a transaction is one of the most important features of the system. Any registered user in the system may rate the transaction with several variations. As a basic methodology, the user opens the transactions to enter a rating upon inspection of the account details and leaves his opinion about the particular transaction listed at the account screen (FIG. 6A). If user already rated a transaction, he will receive a notification after any change on that transaction by its owner. System may assume that any user who rated a transaction reviewing his mark according to a renewed transaction's info. For example account holder (client), who initiated the transaction, may leave comments about this given transaction, or attach some documents to it, etc. After that it may be important for the user, who already rated this transaction, to look at the updated information about the transaction again and to check the updated information about the transaction and possibly to change the mark.

A user may rate the transaction due to personal curiosity or in according to the tasks of the system to evaluate the transaction of any particular account that user follows. In other words, system of the present invention involves users to check the transactions and evaluate them. Such social activity may increase the reliability of the provided data.

A user may rate the transaction based on the available information about transaction, namely, as mentioned above, based on bank data about the transaction, attached invoices, rating of other users, comments of other users. Moreover, any user may rate the comments for using any of a selected group of categories, for example: useful/useless/boring/spam. Also the user may take into account information about categories of spending, information about the counteragent, the history of communication with the system, or the source of funds for a specific transaction. Moreover, insight may be provided by a system, wherein the insight takes the form of a weighted scoring system structured with analytical tools. For example: Each of possible response has its weight. The weight of the particular response is taken into account in the overall assessment.

For example:

A response for a transaction of “OK” may have the weight (+1). Examples of alternate weightings could be

“Not yet rated”—(0);

“Confusing me” (−1):

Do not agree with the Category (−2):

Do not agree with the Recipient (−3):

“Should be cheaper/too much for budget”, “Too expensive” (−4):

“Does not fit the Goal”, “Inappropriate expenses”<<X>> (−5):

In such an embodiment, the overall assessment may be computed as the arithmetic mean of all responses.

A user may specify the level of trust to the account holder. The user may specify whether trusts the account holder his trusted to use the money, or doubt the validity of such consumption. The user can also join the evaluation of other users, if the user agrees with the ratings and comments.

With a positive response for a request to evaluate the trust level of the account holder, the weight of the user's voice is taken into account in the overall assessment.

With a negative response, the weight of the user's voice is also taken into account in the overall assessment, and the user may specify the cause of dissatisfaction by choosing one of the options, which is also a negative impact on weight (ascending negative weight).

For example, the user may explain the reason as: “just do not understand it”, “wrong category for this transaction”, “do not trust the recipient”, “it may be done cheaper”, or “too expensive for the general budget”, “it does not refer to the specified goal”, or “another reason”.

The user may simply leave a comment, without evaluation, ask about the specific account, and then get a personal answer, or simply provide useful information. There is also an option to share an assessment of the transaction in the social networks. Optionally, a user may add a comment to the publication of the assessment.

An option exists for “Spending Rating on System request”. In this option, the user may get a request from a system to rate some outgoing transactions from the account to which the user contributed. This a particular example of a task (job) that is specifically requested of a user. For example, the user may receive a request from the system to inspect and rate money being spent from an account.

Following the link from a notification, the user may be directed to an account page. Transactions for which the user has been asked to rate the transaction are marked in the common list. In separate detailed notifications, (e.g. by e-mail) there may be a list of transactions that can be rated with a link to each.

By navigating to the page the user will also see other transactions, besides the ones suggested for rating, and can continue working or comment on a requested or non-requested transaction. To avoid fraud by a user and to avoid inefficient and inappropriate user feedback, the system seeks ratings from random and uninterested users. If a registered user is not followed or a rating not completed, the system stores the information. The system may have an algorithm to rate the particular transactions of users of the system who are totally independent from the initiator of a transaction to provide an independent and objective assessment.

It may be an intellectual program (may be a machine learning algorithm) that may analyze accounts, transactions, activity of users, and creates effective task for independent users.

Independent may mean that they are not interested in success or fail of each other. After a rating the user may be shown how his “Karma” history has changed over time. The user can later see all ratings in his dashboard (FIG. 5). In such an embodiment, every registered user may have an index of reputation within the system, in other words “Karma.” This index of reputation may be calculated based on the key indicator of social activity within the system.

Referring again to FIG. 6A links News 619 redirects a user to the page with a news feed of events. The browser (or application) page may include the following details, such as a list of events and changes of account. Every item of this list may be reviewed and redirect to the page with the object that was the initiator of the changes or event. FIG. 6B illustrates an example screen with account news 619. Illustrative events are represented in the block 630 with date of event, initiator and the short description of the event. For example, based on the information from the feed of events, any user may view that Pieter Clark transferred to the account 1000$ at 12/03/2015.

Referring to FIG. 6A, the system may have a button 613 for publishing bank account data. Button 613 allows publishing all information about the account. If the client does not want to share the information, the client may press the button 613 to hide the account. The fact that user wants to hide information about the account will be also available for other users. There is no option to publish only a part of information about the transactions in the system. By electing to hide the transaction, all information about the account (including title and account holder) will be hidden, but not deleted. There is no option to delete the information from the storage of data. When the account holder wishes to open the account information, all hidden past data will again be available for users.

### Account Analysis

The system provides a tool for analysis of data that is collected within the data storage facility. This tool for analysis is available to any user of the system. In one embodiment, a user who donates money to an account of project or who is just a curious user wishes to review how a project manager (account holder of a project, for example crowd funded project) uses the donated money. The user may want to know how fast, how efficient, and on what the money was spent.

Users may have different motivations to explore and investigate information about money spending from an account. The first reason is personal curiosity. In case of personal curiosity, users may just surf the data to get common understanding of what is going on behind the project or company they are interested in.

If users have already donated or invested their money in the project, they will probably be particularly interesting to see how the account holder spent their money. In this case, the opinion of experts can give them the confidence that they have made a good investment. As was mentioned above, experts may comment on a transaction, or evaluate a transaction or series of transactions, thereby increasing or decreasing the rating of a transaction or series of transactions.

In another case project managers and companies can learn effective ways to use the money that help others achieve outstanding results. Tools for analysis and compare statistics may be uploaded to system.

Another option is usage transparency. For an account of a project, a searching utility is provided so the user can identify similar projects. For example if a project manager opened a transparent account and properly configured the account with the pertinent data to be searched to identify and select projects that solve similar problems. Another option is for investors to establish periodic reports on budgets or on the use and return of their investments.

Referring to FIG. 6A, links of account analysis 621 may redirect to the page with analytic tools. Analytical tools allow the user to receive data about transactions from storage of data in the standardized form. A page with analytics tools 621 is illustrated in FIG. 6C. This page allows the user to generate and publish any types or reports based on data relating to money transfer in a particular account, including the option of filtering of transactions, reviewing the structure of money spending, etc. The browser (or application) page may include tools for analytics, such as aggregate statistics about dynamics of account balance. Based on these source data, statistical analysis may be performed, different pivot tables and charts may be created, such as charts of amount of payments and money transferring to the account and charts of amount of expendable transactions and money transferring from the account may be created. Moreover, the information about geography of payments (incoming transactions), geography of expenses (outgoing transactions) is available.

Statistics tools allow analyzing the community of an account. For example, the system may generate a growth chart of account community, track amounts of community members, or assess their evaluations or comments.

The present invention provides a possibility to compare different accounts between each other. A user or client may manually identify the accounts to be compared, or the system may suggest similar accounts for comparison. The user may choose the parameters for comparing, for example by the balance of account, by the purpose of account, by account holders, etc. A tool for comparing account data is especially useful for comparing projective accounts or corporate accounts to determine the strategy of realization of the projects, determine service providers based on the published details of transactions, optimize the costs, etc. In other cases, the user may compare project A and project B based on the published information about the projective accounts of said projects to identify the most attractive project for investing.

### Analytics Tools:

For a detailed study of the account, the system provides analytics tool that allows a user to easily obtain a large amount of data such as the overall dynamics of funds on the account, distribution and dynamics by the category or by types of counteragents, statistics of evaluations, statistics by frequency and transaction size, calendar dynamics, filtration and search.

The overall dynamics of funds on the account may comprise an amount of receipt of funds to the account, amount of outgoings transaction, or state of balances over time.

Tools for tracking distribution and dynamics by the category allows users to view which directions are indicated for budgeting, and how funds are spent for each of the directions.

Tools for tracking distribution and dynamics by the category allows determining types of counteragents and represents the distribution for each, their correlation with categories, and determined by the account holder.

Statistics of evaluation allows the user to view how often other users evaluate the transactions of account, how many evaluations and what evaluations are given, how fast account holders answer the negative evaluations, how often account holders answers help the user, and how many people are involved in the conversation of the account or of the particular transaction. Also changing the ratio of evaluations, (dynamics in time) may be tracked and analyzed.

Statistics by frequency and transaction size allow the user to track how often and in what amounts the account owner spends and receive funds. The user might track major or minor expenses as incurred and may categorize spending and identify the recipient. Additional information about the average size of donations, repeated donations, average age of donors, sex of donors, tools of donations (check, card, bank transfer), etc. may be also available.

A dynamic calendar aggregates information of profile of funds by years, months, weeks and even days. To find the specific data, the user may use flexible search/filter data transaction.

### Planning of the Payments.

An account facility in the system allows planning future payments. By creating a new payment, the account holder has an opportunity to send an intended or scheduled draft of future payments, but not execute payment immediately. Then, on a separate page the future transaction will appear along with a designation that the transaction is “unfinished”. “on the approval” or “returned by bank”, and/or other statuses of accomplishment.

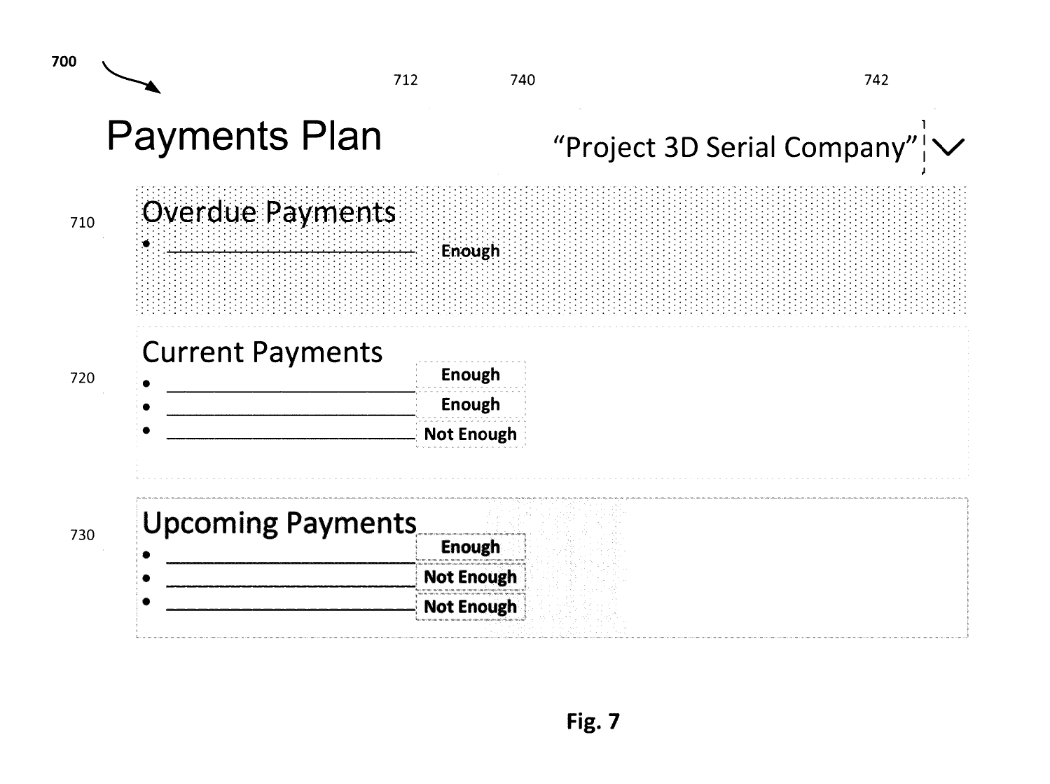

One of the functions of the present invention is to plan future transactions with the account. Namely, the system allows registering new payments, or creating new payments based on the invoices, adjusting their periodicity, planning the graphic of expenses and expectable incomes within the balance, and evaluating available balance. The main purpose is to provide the powerful instruments for planning and provide user-friendly overview of the state of information of an account. FIG. 7 illustrates the example browser page or page in the mobile application 700, which may be used for interaction by a user with a system for planning and completing payments.

For example, the page or screen for planning of future transactions may be used as an interface of communication of the user or client with the system of the invention. Mainly the module for planning represents the chronological list of payments. This module allows to view current payments 720, overdue payments 710 and future payments 730. Labels may visually distinguish each type of payment. Visually distinguishing the payments allows categorizing any series or segment of payments (outgoing transactions) into groups.

The planning module also allows the user to identify upcoming bills that are considered to be important to the user. For example, the details of payment may be preliminarily prepared by the account holder, subject only to approval to complete the payment. The account holder may complete the preliminarily prepared payment with only one gesture, such as swiping the touch screen of the mobile electronic device.

The account holder may also delay the payment for a day, week, etc. Tools for managing upcoming bills on a timeline allow review of an upcoming payment date. Moreover the planning tool allows the user to review the payments that may be accomplished due to adequate ability on the account, and when payments may be completed when the account holder receives funds into the account. Indicator 712 may show that the funds are enough to complete the payment. Also account holder may view the repeated transaction (regular, periodical, cyclic).

The title of the project, or company or title of personal account may be specified 740. A dropdown list may allow to choose another account for payment planning.

### “Payment to a Partner/Client Project”

As was illustrated in FIG. 1B any user 152-157 may deposit money to the registered account in the system. There are different ways for a user to deposit money to account it is not the account holder. The first variant is a deposit coming from the website of a partner. For example, a user comes to a project page where a payment form of any conventional type is embedded in the page. Near the collected money amount within the website of a partner, and in payment form, there is a special indicator icon/logo indicating that the Project Account is transparent and money spending information is public. This special indicator (for example, icon/logo) is purposed for distinguishing the projects for which a transparent account is registered within the system of the invention. In this embodiment, a guest affiliated with a partner, such as a fundraiser, accesses the system, chooses an amount and other payment details on the project site, and makes a payment. For example, a crowdfunding platforms may provide visitors an opportunity to donate to some projects through the platform of the invention.

### Brief Information Re: Computers and Electronic Systems

The method for providing publishing information of the transactions with a bank account, users (person or company), access the system via a for example, a browser application running on the user's processor-controlled device, such as a laptop, desktop, notebook, or smartphone. In this implementation, the service comprises a web site served by one or more web servers, generally incorporated within a large distributed-computing facility, such as a cloud-computing facility.

The system of invention comprise a large data storage that is allocated between a large number of servers.

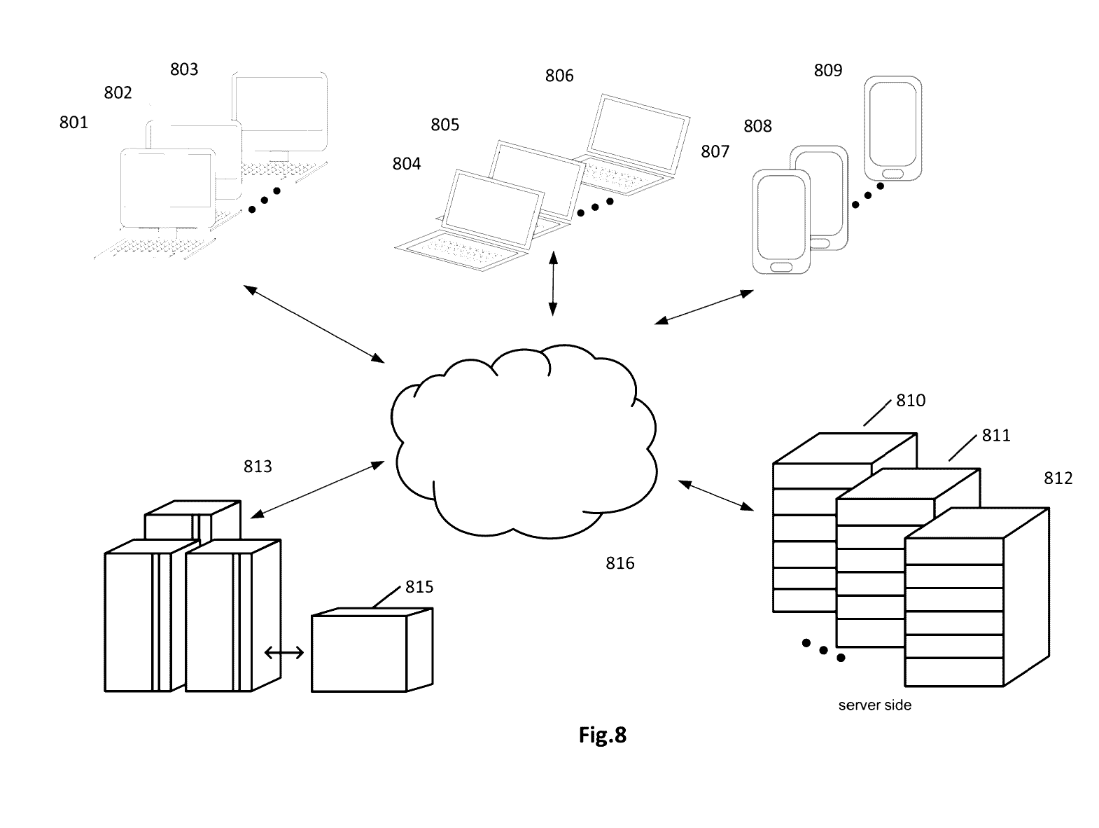

FIG. 8 illustrates a distributed computer system that has a connection with the Internet. In one implementation, the distributed computer system is a client server system, wherein the service of opening a transparent account and publishing of a transaction history is provided from a central source. A single server provides many clients (users, companies etc.) with the ability to use the service for personal goals. Clients and servers have different tasks. The server's task is to respond to service requests from clients, while a client's task is to use the data provided in response in order to perform some tasks. FIG. 8 represents a distributed system with a large number of personal computers 801-803, laptops 804-806, mobile phones 807-809, a high-end distributed mainframe system 814 with a data-storage system 815 and a computer center 810 with a plurality of servers or blade servers all interconnected through various communications and networking systems that together comprise the Internet 816. Such distributed computing systems provide diverse arrays of functionalities. For example, a personal computer user in a home office may access hundreds of millions of different web sites provided by hundreds of thousands of different web servers throughout the world and may access high-computational-bandwidth computing services from remote computer facilities for running complex computational tasks.

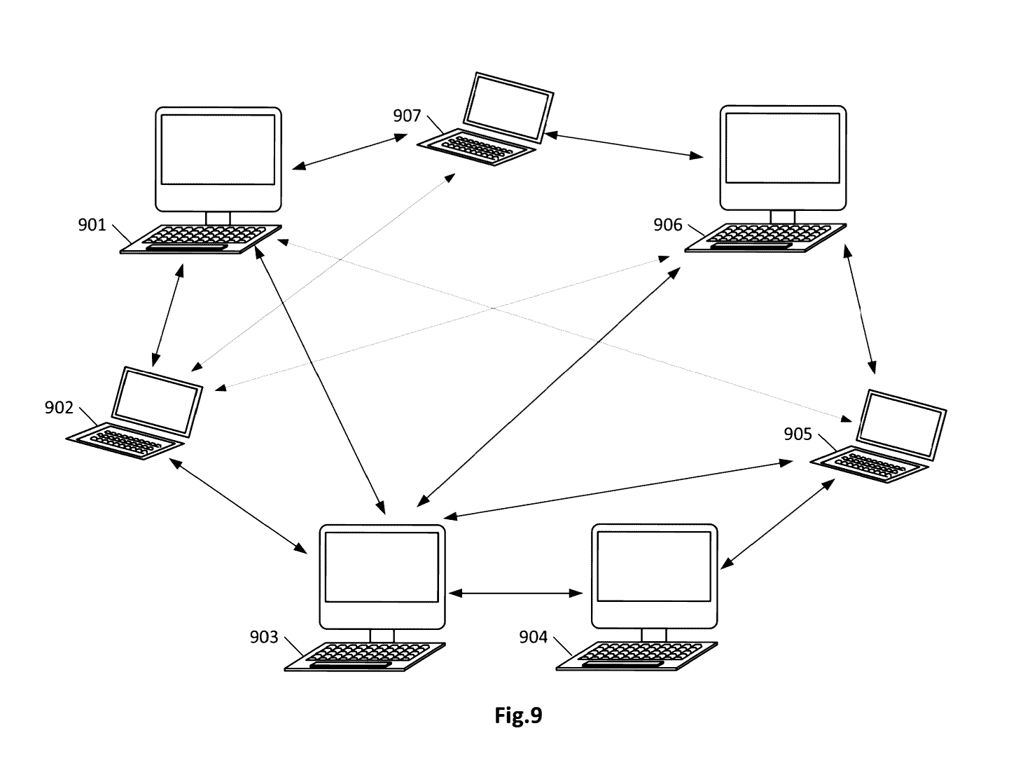

In another possible implementation, peer-to-peer computing or networking may be used, wherein peer-to-peer computing or networking is a distributed application architecture that partitions tasks or workloads between peers. FIG. 9 illustrates another network in which interconnected nodes (“peers”) 901-907 share resources amongst each other without the use of a centralized administrative system. Peer- to peer computing network allows validation of data and storage on a processor-controlled user devices or other user's computer-based systems. The processor-controlled user devices or other user's computer-based systems have at least one processor unit, memory unit, and data-storage unit. The processor-controlled user devices electronically communicate with other remote processor-controlled user devices and servers of the platform 110. The processor-controlled user devices store the data about the transaction and activity of the user or client. The platform 110 may exchange data with processor-controlled user devices and request information to validate transaction data to avoid data corruption in case of possible tampering.

1. A method for a publishing a financial account transaction data for review by a user comprising:
1) entering the financial account data into the platform, wherein the platform comprises a data repository for assembling and storage said financial account data, wherein the data repository is located within at least one computer-based system or server, wherein the computer-based system or server has at least one processor unit, memory unit, and data-storage unit, and wherein the at least one computer-based system or server electronically communicates with remote processor-controlled user devices through a communications environment;
2) processing the financial account data to store the source of the financial account data without an ability of any party to alter the financial account data;
3) publishing the financial account data to permit user access to the financial account data, wherein at least one computer-based systems or server to receive requests from the processor-controlled user devices and transmit responses to the requests to the processor-controlled user devices, wherein the processor-controlled user devices comprise an interactive user graphical interfaces for interaction of user with the platform; wherein the requests comprise:
receiving information about financial account data by the processor-controlled user devices;
4) receiving a user response regarding the financial account data from the processor-controlled user device.

2. The method of claim 1, wherein the financial account date is a transaction and the information is selected from the group consisting of: a value of the transaction, a category of the transaction, a date of the transaction, a name or title of a recipient of the transaction, a bank of recipient of the transaction, a name or title of an initiator of the transaction, a bank of the initiator of the transaction, a goal of the transaction, evaluation and comments of the transaction, and combinations thereof.

3. The method of claim 1, wherein the financial account data is selected from the group consisting of: title of account, balance of account, date of opening of account, name of account holder, the personal information about account holder, reputation of account holder, purpose of the account, information about followers, number of followers, information about transactions, comments within the community of the account, and rates of transactions, and combinations thereof.

4. The method of claim 1, wherein the financial account is maintained by a financial institution, wherein the financial institution permits a transaction with the financial account data and stores the information about the transaction for user access.

5. The method of claim 4, further comprising the step of granting access to the financial account data by receiving access to a data storage facility containing the financial account data within the financial institution.

6. The method of claim 1, further comprising the step of establishing a community of user members who access the financial account data and wherein information about the community of user members is posted to the data repository.

7. The method of claim 6, wherein a comment by a user member is transmitted to data repository with respect to the community for storage and subsequent distribution to the processor-controlled user devices, of the user members of the community.

8. The method of claim 1, wherein the user response is a rating of the published financial account data and is selected from the group consisting of: an indication of like, an indication of trust, an indication of dislike, and an indication of doubt, and combinations thereof.

9. The method of claim 8, wherein the rating is transmitted to the data repository with respect to the community for the financial account data and is available to user members of the community.

10. The method of claim 8, wherein the user response is shared with user members of the community.

11. The method of claim 1, further comprising the step of displaying a profile of the owner of the financial account data comprising an identity of the owner and goal of a transaction involving the financial account data.

12. The method of claim 1, further comprises the step of displaying a profile of the user wherein the profile contains information selected from the consisting of first name, last name, date of birth, email, residence or mailing addresses, personal information with photos of person, links to profiles in the social networks, and combinations thereof.

13. The method of claim 1, wherein the step of publishing the financial account data includes identifying future financial transactions involving the financial account data.

14. The method of claim 1, wherein the step of publishing the financial account data includes displaying a continuous account balance reflecting transactions involving the financial account data.

15. The method of claim 1, wherein identical published financial account data is simultaneously available for all users interacting with the platform by the processor—controlled user devices.

16. The method of claim 14, further comprising displaying a specific goal amount for accumulated transactions as an element of the financial account data and comparing the specific goal amount to the current continuous account balance.

17. The method of claim 1, wherein the user response comprises a social activity based on the published financial data, the social activity selected from the group of commenting published financial account data, rating the published financial account data, sharing the published financial account data, and auditing the published financial account data, and combinations thereof.

18. The method of claim one, further comprising processing the published financial account data with statistical tools.

19. The method of claim one, further comprising the steps of: (1) comparing the published financial account data of a first financial account with published financial account data of a second financial account, and (2) providing the results of comparing the published financial account data of the first financial account with the published financial account data of the second financial account.

20. The method of claim 1, further comprising tracking movement of the financial account transaction data by proof-of-records principles.
